(19) United States
(12) Patent Application Publication
(10) Pub. No.: US 2017/0262807 A1
(43) Pub. Date: Sep. 14, 2017

(54) Community Led Open Innovation

(71) Applicant: H. Brock Kolls, Alpharetta, GA (US)

(72) Inventor: H. Brock Kolls, Alpharetta, GA (US)

(21) Appl. No.: 15/067,220

(22) Filed: Mar. 11, 2016

(51) Int. Cl. G06Q 10/10

(52) U.S. Cl. CPC G06Q 10/101

(57) ABSTRACT

The present invention relates to a community led open innovation system and method, operated over a global network, in an online community format that engenders increase in the technology transfer rate of technologies, technical resources, and technical capabilities to a CORPORATE COMMUNITY from a TECHNICAL COMMUNITY, comprising the steps of creating a TECHNICAL TARGET based on a NEED from a CORPORATE MEMBER, sharing the TECHNICAL TARGET with the TECHNICAL COMMUNITY, routing to the CORPORATE MEMBER a PROPOSED SOLUTION to the TECHNICAL TARGET, the PROPOSED SOLUTION being initiated by the TECHNICAL COMMUNITY MEMBER, and facilitating an introduction, related to the PROPOSED SOLUTION, by way of a transitory digital communication between the CORPORATE MEMBER and the TECHNICAL COMMUNITY MEMBER.

### CROSS-REFERENCE TO RELATED APPLICATIONS

This application contains subject matter which is related to the subject matter of the following co-pending application. The below listed application is hereby incorporated herein by reference in its entirety:
This application is a continuation of a U.S. provisional application, Ser. No. 62/149,627, inventor H. Brock Kolls, entitled “COMMUNITY LED OPEN INNOVATION”, filed Apr. 19, 2015.

### TECHNICAL FIELD OF THE INVENTION

This invention relates to a community led open innovation system and method, operated over a global network, in an online community format that engenders increase in the technology transfer rate of technologies, technical resources, and technical capabilities to a CORPORATE COMMUNITY from a TECHNICAL COMMUNITY.

### BACKGROUND OF THE INVENTION

With reference to prior art FIGS. 1A and 1B, the Figures illustrate examples of prior art corporate led innovation, before our invention for most corporations, in one form or another, they had an innovation or research and development (R&D) process 412. Such process 412 often consists of a series of stage gate steps to convert ideas into products or services. Thirty or so years ago a majority of products and services came out of corporation R&D processes 412 which, in large part, involved ideating to generate ideas and then researching and developing to convert the ideas into products or services. In fact, it is estimated that up through the mid 1980's or so, as much as 85% of new products and services came from corporate innovation and just 15% or so came from external sources such as startup companies.

More recently, in prior art corporate led innovation processes, a corporation could work externally, as example, with institute 406, university 410, and startup 408; however the leadership and control of the R&D process 412 resided internally and under control of the corporation 402. In this regard, the external relationships with institute 406, university 410, and startup 408 were guided by what the corporation determined to be the R&D stage gate process and the corporation set the pace of the decision making and other aspects of the innovation process; such process time often being lengthy and bureaucratic in big corporations.

Though perhaps an appropriate arrangement at one point in time, by the mid 1990's and the inception of the Internet, things began to change in the corporate world on the innovation front. With the rise of the Internet, readily accessible knowledge began to grow faster on the outside of corporations then on the inside. The smartest people suddenly seemed to be working for someone else. No longer was the corporate lab the place where abundant knowledge resided. As such, it is now estimated that as little as 15% or so of new products and services come from corporate innovation and much as 85% or so come from external sources such as startups.

This realization was articulated by Dr. Henry Chesbrough in his 2006 book entitled OPEN INNOVATION. The term OPEN INNOVATION was coined by Dr. Chesbrough and has become emblematic of the realization that not only was there more knowledge available outside the corporation but that the knowledge was organizing itself into networks that seemingly could be accessed, more or less, on an as needed basis.

It became clear, rather quickly, that these external networks were becoming more innovative then corporate labs, sharing better ideas and building products and services quicker, cheaper, and with fewer resources expended. Suddenly, innovation was being done differently and in a manner consumers were responding to. The slow and bureaucratic corporate environment had met its match.

Another realization shortly followed that not only were these external networks connected, collaborating, and speeding innovation, but these networks were not beholden to doing innovation the “old corporate way”. Old business models were discarded for novel new approaches, which systematically changed the entire paradigm of the innovation landscape, touching virtually every industry and impacting virtually every corporate business model.

Beholden to their own existing business models, corporations have found it difficult to envision how to adjust and adapt to this kind of innovation “change” in such a short time period and as such have seen pressure on their declining revenues and stagnation in their innovation pipelines. There has been an awakening inside corporations of their diminished ability to innovate to grow with internal resources alone, but there has been epic struggle as to how to embrace an external entrepreneurial world of innovation. All too frequently now corporations are waking up to realize the industries they once new have changed, and suddenly they have become a stranger in a market they once controlled. This is perhaps, notoriously, often referred to as a corporation's ‘KODAK moment’, with reference to KODAK'S inability to embrace the digital camera revolution, though they in part invented it, instead clinging to the vanishing film and paper business model until it was too late.

Realizing something needed to be done to reinvigorate corporate innovation, about a decade ago, corporate thinking was to ‘supplement’ their existing innovation capability with some of Dr. Chesbrough's OPEN INNOVATION external network and process theories. Perhaps the comment that started it all was when the P&G CEO A. G. Lafley, around 2006, stated that P&G was going to ‘supplement’ their internal innovation, setting a goal to acquire 50% of their innovation from outside the company.

The ‘supplement’ strategy, using OPEN INNOVATION to, in effect, strap on some external resources, such as institutes 406, university 410, and startup 408, gave rise to many interpretations, and corporations began forming internal groups around new business model creation, intellectual property in-and-out licensing, external technology acquisition, connect-and-develop concepts, and on-and-on with many other incarnations. These terms of art became common place, in corporate halls, and senior leadership began buying and reading books to try to understand what was happening in the innovation world around them. Many of these senior leaders openly wondered, within the corporate walls, why and how innovation had become so different so quickly. But with little if any entrepreneurial or startup experience it has been largely an academic corporate exercise, plotting how to augment their existing innovation or R&D processes to compete in this new paradigm.

What was supposed to be easy; to increase innovation by adding external resources to one's existing internal capabilities, suddenly became a corporate culture revolution, and one not for the faint of heart. Change in a corporate environment can be traumatic and something that has become a frequent topic of conversation in OPEN INNOVATION forums. New ideas often are seen as ‘attacking the current beloved business model’. Something the ‘corporate immune system’ would be dispatched to neutralize by stopping threatening new ideas. In many cases, not only the ideas were neutralized but the leaders and entrepreneurs bringing the new ideas and processes in often became targets as well.

Fast forward to today, as example, and as illustrated in FIG. 1B, as more and more corporations try their hand at OPEN INNOVATION, you have many corporations 402A, 402B, 402C each running their own and different innovation processes, each working to creating external networks and relationships in some manner with institutes 406A, 406B, startup 408A, 408B, 408C, and universities 410A, and 410B. In addition, you have investors 404A, and 404B trying to figure out who is working on what, with whom, and struggling to determine if the relationship between the external idea creators and the corporations makes good business sense so that they can decide whether or not to make an investment.

You add to this chaos that each corporation has a different innovation process and often different relationship making process for interfacing to the external community, and you get, from the external community perspective, an often inoperable maze of relationships that look totally confusing, disorganized, and largely non-function and ineffective. Perhaps a bit akin to a card game with different rules for each player.

In the external community (institutes, startups, universities, investors) portrayed of FIG. 1B, not only are their many corporation innovation processes being experimented with and playing out with varying levels of success inside the corporation, but this is happening at the expense of the external community. In this regard, corporations seemingly are always in a state of change, all trying to figure out what type of innovation process works best for them. Typically, most corporate innovation processes are consistently failing into another form which is trying to improve on the old process. This happens so frequently that no one in the external community can really figure out how to maintain a relationship with a corporation for very long.

The net effect is that likely any external idea that makes its way into a corporation quickly is smothered and dies. If innovation was not hard enough already, imagine how hard it is for the external entrepreneur or startup company to figure out how to work with a corporation.

From the perspective of the external community of institutes, startups, universities, and investors, working with corporations can be long winded, resource consuming, potentially idea or company killing, and an absolutely frustrating endeavor. Is it really any surprise that when you take a fast moving novel idea from outside the corporation and import it into the corporation's slow, often inefficient, and ever changing innovation process, there is little chance of success?

After all, what the corporation's innovation process doesn't kill the corporation's immune system will likely track down and eliminate. Maybe the simple insight here might be if a corporation could innovate internally it would not need to go external for solutions; right? Why then would you think bringing an external solution into the same internal process, an internal process unable to innovate their own ideas, a different outcome would be expected.

To the defense of the corporation's they know these internal challenges exist and have of late been willing to explore new ways to innovate. In this regard, many have tried incubator or accelerator business structures, such as small entrepreneurial teams or physically locating a lab external to the corporation (away from the corporate center). Observation has been that as long as corporate influence touches these structures sooner than later the objectives are aligned to the corporation's known and well entrenched expectations and processes, and as such these programs more often than not are consumed and assimilate into the matrix of the corporation quickly losing their innovative edge and producing little business value.

It begs the question why should the external community work with corporations at all? Well the simple answer might be corporations often know the ‘needs’ of the market, they have the money to fund work, and they have market access to sell products and services often at large scale. It is these corporate resources and scale that the external community full of brilliant, but under-funded, ideas largely does not have and desperately needs.

In addition to the shortcomings above, another shortcoming can be that when each of a group of corporations set and lead innovation with their own processes and external community relationship terms and conditions, it is confusing to all and prevents the adoption of a common language of innovation which would benefit the entire community. A common language of innovation would allow all of the corporations and all of the external technical communities to commonly discuss and communicate the metrics of technology along the lines of technical readiness, opportunity value, complexity of the solution, probability of success, and other metrics.

Another shortcoming, within the technical community, can be that there is not a common formal reporting mechanism for these and other metrics which can help corporate senior leaders make informed decisions quickly. Simple stated, well informed senior leaders in corporations need a formal process so that they can assess options and can make decisions faster, which could help speed up innovation with the technical community.

Another shortcoming can be that absent a common language, common reporting mechanism, and common external technology innovation method, it is difficult for the investor community to monitor the opportunity flow between corporations and the technical community so that they can make informed investment decisions.

Another shortcoming can be that it takes too long to wait for a startup company to be able to build the capability and resources necessary to deliver a solution at scale that derives the kind of revenue that a corporation needs and recognizes as significant. Corporations often operate on quarterly reporting cycles and need to quickly bring a solution to market, at scale, to have a meaningful BUSINESS IMPACT. Absent the common language around readiness, risk, and a common innovation method it can be difficult to determine the capabilities which can be solved through partnering, such as with mentors and retirees to advise the startup company and with supply chain partners who have already demonstrated logistical and market execution capabilities that can help to quickly launch products and services at scale.

For these reasons and shortcomings as well as other reasons and shortcomings there is a long felt need to get breakthrough innovation out of the entrepreneurial and startup technical community and launched with corporations, at scale, faster, that gives rise to the present invention.

### SUMMARY OF THE INVENTION

The shortcomings of the prior art are overcome and additional advantages are provided through the provision of a community led open innovation method, operated over a global network, in an online community format that engenders increase in the technology transfer rate of technologies, technical resources, and technical capabilities to a CORPORATE COMMUNITY from a TECHNICAL COMMUNITY, the community led open innovation method comprising the step of creating a TECHNICAL TARGET based on a NEED from a CORPORATE MEMBER, the CORPORATE COMMUNITY further comprising the CORPORATE MEMBER. Additional steps include sharing the TECHNICAL TARGET with the TECHNICAL COMMUNITY, the TECHNICAL COMMUNITY further comprising at least one of a TECHNICAL COMMUNITY MEMBER, routing to the CORPORATE MEMBER a PROPOSED SOLUTION to the TECHNICAL TARGET, the PROPOSED SOLUTION being initiated by the TECHNICAL COMMUNITY MEMBER, and facilitating an introduction, related to the PROPOSED SOLUTION, by way of a transitory digital communication between the CORPORATE MEMBER and the TECHNICAL COMMUNITY MEMBER.

Additional shortcomings of the prior art are overcome and additional advantages are provided through the provision of a community led open innovation method, operated over a global network, in an online community format that, engenders increase in the technology transfer rate of technologies, technical resources, and technical capabilities to a CORPORATE COMMUNITY from a TECHNICAL COMMUNITY, the community led open innovation method comprising the step of creating a TECHNICAL TARGET based on a NEED from a CORPORATE MEMBER, the CORPORATE COMMUNITY further comprising the CORPORATE MEMBER. Addition steps include sharing the TECHNICAL TARGET with the TECHNICAL COMMUNITY, the TECHNICAL COMMUNITY further comprising at least one of a TECHNICAL COMMUNITY MEMBER, routing to a COMMUNITY FACILITATOR a PROPOSED SOLUTION to the TECHNICAL TARGET, the PROPOSED SOLUTION being initiated by the TECHNICAL COMMUNITY MEMBER, the COMMUNITY FACILITATOR is an intermediary agent for the CORPORATE MEMBER, and facilitating an introduction, related to the PROPOSED SOLUTION, by way of a transitory digital communication between the COMMUNITY FACILITATOR and the TECHNICAL COMMUNITY MEMBER.

Additional shortcomings of the prior art are overcome and additional advantages are provided through the provision of a community led open innovation system, operated over a global network, in an online community format that engenders increase in the technology transfer rate of technologies, technical resources, and technical capabilities to a CORPORATE COMMUNITY from a TECHNICAL COMMUNITY, the community led open innovation system comprising a plurality of digital devices, and a server having data communication access across the global network with the plurality of digital devices, the server further comprising a data storage memory. The data storage memory encoded with instructions which when executed perform the steps of creating a TECHNICAL TARGET based on a NEED from a CORPORATE MEMBER, the CORPORATE COMMUNITY further comprising the CORPORATE MEMBER, sharing the TECHNICAL TARGET with the TECHNICAL COMMUNITY, the TECHNICAL COMMUNITY further comprising at least one of a TECHNICAL COMMUNITY MEMBER, routing to the CORPORATE MEMBER a PROPOSED SOLUTION to the TECHNICAL TARGET, the PROPOSED SOLUTION being initiated by the TECHNICAL COMMUNITY MEMBER, and facilitating an introduction, related to the PROPOSED SOLUTION, by way of a transitory digital communication between the CORPORATE MEMBER and the TECHNICAL COMMUNITY MEMBER.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A and 1B illustrates examples of prior art corporate led innovation;

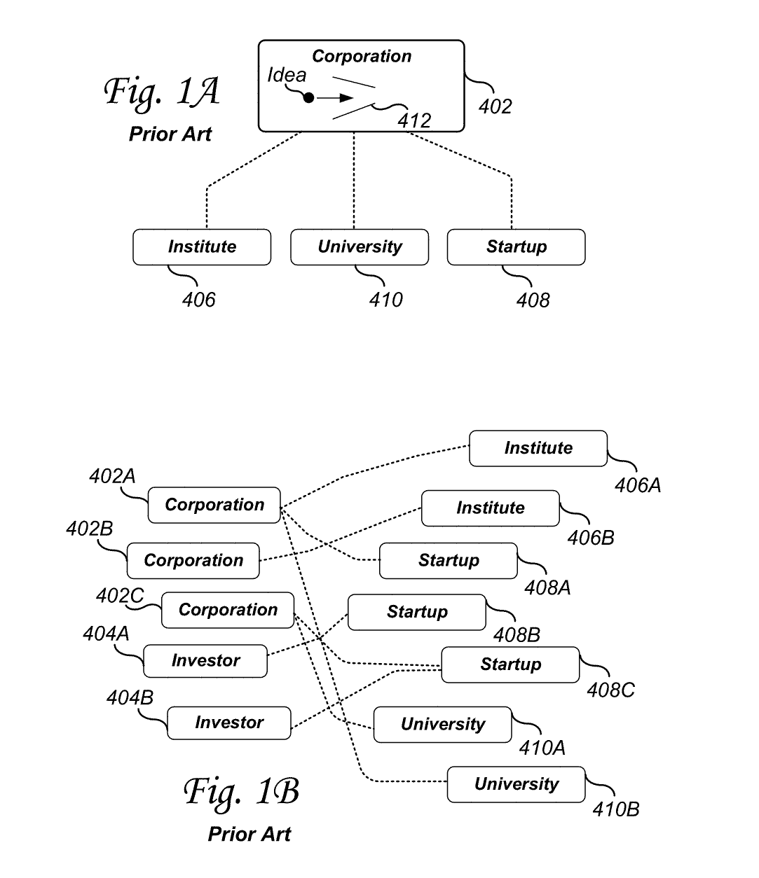

FIG. 2 illustrates one example of a COMMUNITY LED OPEN INNOVATION system and method;

FIG. 3 illustrates one example of OPPORTUNITY flow through the COMMUNITY LED OPEN INNOVATION system and method;

FIG. 4 illustrates one example of a COMMUNITY LED OPEN INNOVATION organizational layout;

FIG. 5 illustrates examples of STATEMENT OF WORKS and OPPORTUNITY categories;

FIG. 6 illustrates one example of community members interacting over a global network utilizing the COMMUNITY LED OPEN INNOVATION system and method;

FIG. 7 illustrates one example of a method of progressing an OPPORTUNITY through the COMMUNITY LED OPEN INNOVATION system and method;

FIGS. 8, 9, 10, 11, 12, and 13 illustrate examples of a PORTFOLIO VISUALIZATION software tool to visualize PIPELINE ACTIVITY;

FIG. 14 illustrates one example of a TECHNOLOGY READINESS table;

FIG. 15 illustrates one example of a OPPORTUNITY VALUE table;

FIG. 16 illustrates one example of a COMPLEXITY CONFIDENCE LEVEL table;

FIG. 17 illustrates one example of a PROBABILITY OF SUCCESS QUESTIONNAIRE comprising MATHEMATICALLY WEIGHTED QUESTIONS;

FIG. 18 illustrates one example of a COMMERCIAL READINESS QUESTIONNAIRE comprising MATHEMATICALLY WEIGHTED QUESTIONS;

FIG. 19 illustrates one example of CORPORATE COMMUNITY RATINGS;

FIG. 20 illustrates one example of TECHNICAL COMMUNITY RATINGS;

FIG. 21 illustrates one example of INVESTOR COMMUNITY RATINGS;

FIGS. 22A, 22B, 22C, 22D, and 22E illustrate examples of COMMUNITY LED OPEN INNOVATION method operated over a global network;

FIGS. 23A, 23B, 23C, 23D, and 23E illustrate exemplary embodiments of COMMUNITY LED OPEN INNOVATION method operated over a global network; and

FIG. 24 illustrates one example of a COMMUNITY LED OPEN INNOVATION portfolio management framework.

The detailed description explains the preferred embodiments of the invention, together with advantages and features, by way of example with reference to the drawings.

### DETAILED DESCRIPTION OF THE INVENTION

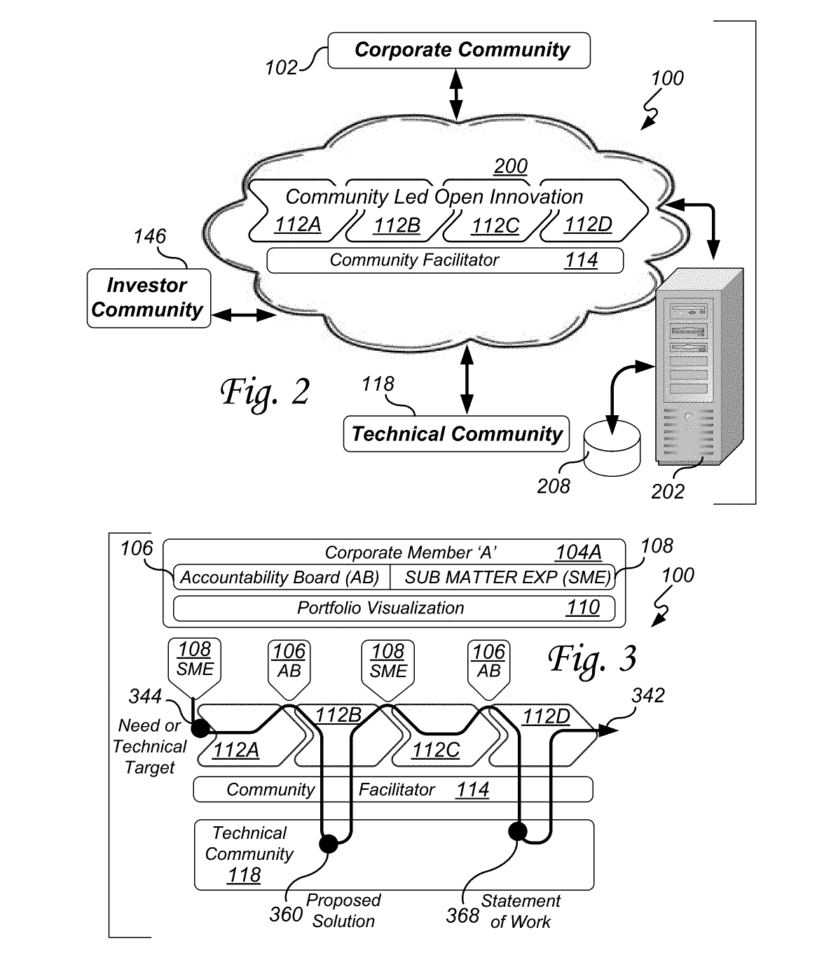

Turning now to the drawings in greater detail, it will be seen that in FIG. 2 there is illustrated one example of a COMMUNITY LED OPEN INNOVATION 100 system and method. In this regard, instead of letting each of a plurality of corporations run their own innovation methods which would be at different points of maturity and executed differently, making it confusing to an INVESTOR COMMUNITY and TECHNICAL COMMUNITY, one common COMMUNITY LED OPEN INNOVATION method 112A-D can be implemented in an online community format. In this manner, all participating corporations, within the CORPORATE COMMUNITY 102, utilize the same COMMUNITY LED OPEN INNOVATION 100 system and method. In addition, the INVESTOR COMMUNITY 146 and the TECHNICAL COMMUNITY 118 also both interface to the online community and access the CORPORATE COMMUNITY 102 through a common COMMUNITY LED OPEN INNOVATION 100 system and method.

Though each of the CORPORATE COMMUNITY 102, INVESTOR COMMUNITY 146, and the TECHNICAL COMMUNITY 118 share the same online COMMUNITY LED OPEN INNOVATION 100 system and method, the data, relationships, communications, and other controls of access and sharing are employed and data and information access restricted as necessary. In this regard, each CORPORATE MEMBER, TECHNICAL COMMUNITY MEMBER, and INVESTOR COMMUNITY MEMBER identity, anonymity, NEEDS BRIEFS, TECHNICAL TARGETS, activity pipeline, STATEMENT OF WORKS (SOW), PORTFOLIO VISUALIZATION, reporting, proposals, PROPOSED SOLUTIONS, community activity, and any other controls of access and sharing can be effectuated to insure that each of the CORPORATE, INVESTOR, and TECHNICAL COMMUNITY members feel they have the necessary security and trusted relationships needed to comfortably embrace and willingly participate in the online community format, as may be required and/or desired in a plurality of exemplary embodiment.

Use of the term “digital device” or “digital devices” or “plurality of digital devices”, in the present invention, is intended to mean smart phones (i.e. IPHONE, ANDROID, MICROSOFT, MOTOROLA, SAMSUNG, APPLE, HTC, NOKIA, and others), laptops, personal computers, tablets, and/or other types and kinds of digital devices, such as digital devices 204, 206, and 110, and similar are all examples of digital devices. Such digital devices having data communication access across global network to servers and other remote data processing resources.

Use of the term “transitory communication” or “transitory digital communication”, in the present invention, is intended to mean a digital communication that resides on a data processing device that is associated with the COMMUNITY LED OPEN INNOVATION 100 system and method that is temporary in nature, as in, it can be deleted or otherwise erased, with no other copies being retained, by a COMMUNITY FACILITATOR or a CORPORATE MEMBER.

In this regard, in an exemplary, not only do the CORPORATE MEMBER and the TECHNICAL COMMUNITY MEMBER remain anonymous but the communication between them stays in the online community, that is, on a data processing resource 202 associated with the COMMUNITY LED OPEN INNOVATION 100 system and method. This allows the CORPORATE MEMBER and the TECHNICAL COMMUNITY MEMBER to have anonymous and non-confidential, introductory type, transitory communications, while protecting the CORPORATE MEMBER and the TECHNICAL COMMUNITY MEMBER identity as well as protect each from receiving into their respective organizations any unsolicited emails, content, or other digital communications that may contain confidential information.

Most organizations have policies on when and what kind of information can be received and typically receiving unsolicited confidential information is not permitted. The transitory communication approach, in the present invention, prevents this scenario from occurring.

In this transitory communication approach, communications reside only on a data processing resource 202 associated with the COMMUNITY LED OPEN INNOVATION 100 system and method; in the online community. As such, a feature in the community is that such transitory communications can be purged or otherwise erased by the CORPORATE MEMBER or the COMMUNITY FACILITATOR.

Use of the term “CORPORATE COMMUNITY”, in the present invention, is intended to mean a collection of, or plurality of, corporations, organizations, non-profits, or other business entities. These generally are considered to be the groups that are sharing NEEDS BRIEFS and TECHNICAL TARGETS with external TECHNICAL COMMUNITIES and INVESTOR COMMUNITIES looking for solutions to business objectives, also referred to as PROPOSED SOLUTIONS.

Use of the term “CORPORATE COMMUNITY MEMBER”, in the present invention, is intended to mean a member of the CORPORATE COMMUNITY.

Use of the term “INVESTOR COMMUNITY”, in the present invention, is intended to mean a collection or plurality of individuals, groups, organizations, venture capitalists, private equity, or other business, non-profit, or other entity that make investments in entrepreneurial ideas, companies, projects, and the like. In general, the INVESTOR COMMUNITY are entities looking for opportunities to make investments of resources such as time, money, or other valuable consideration to advance the development and commercialization of technologies, ideas, and, in general, business opportunities.

Use of the term “INVESTOR COMMUNITY MEMBER”, in the present invention, is intended to mean a member of the INVESTOR COMMUNITY.

Use of the term “TECHNICAL COMMUNITY”, in the present invention, is intended to mean a collection or plurality of groups, institutes, universities, entrepreneurs, government agencies, or individuals that are looking to PROPOSE SOLUTIONS and/or otherwise solve NEEDS BRIEFS and TECHNICAL TARGETS which are presented by the CORPORATE COMMUNITY. Such PROPOSED SOLUTIONS and/or solved challenges can be presented back to the OPPORTUNITY OWNER of the NEEDS BRIEF or TECHNICAL TARGET, in the form of providing a plurality of PROPOSED SOLUTION proposals, where the solution may provide a capability, resource, or provide a technology, as may be required and/or desired in the NEEDS BRIEF or TECHNICAL TARGET.

Use of the term “TECHNICAL COMMUNITY MEMBER”, in the present invention, is intended to mean a member of the TECHNICAL COMMUNITY including an individual, an entrepreneur, a mentor or other professional, a supplier or supply chain partner, another business entity, researchers, research institutes, technology intermediaries, technology sources, technology companies, startups, technology incubators, technology accelerators, organizations, non-profit, or other entities.

Use of the term “NEED”, “NEED BRIEFS”, “NEEDS”, “NEEDS BRIEF”, or “NEEDS BRIEFS”, in the present invention, is intended to mean a brief often non-confidential description of something a member of the CORPORATE COMMUNITY needs. NEEDS BRIEFS vary widely, but as example and not a limitation, can include things like a NEED for a more efficient packaging technology, or a NEED for new non-thermal sterilization processing technologies, or a NEED for a panel of experts to ideate on possible solutions to an aggressive agricultural disease that is threatening crops.

In general, a NEED originates from a CORPORATE COMMUNITY MEMBER and is often assigned to an individual owner also referred to as an OPPORTUNITY OWNER who can interact with (anonymously if necessary) members of the TECHNICAL COMMUNITY and INVESTMENT COMMUNITY, as may be required and desired, to dialog about clarifications of the NEEDS BRIEF, discuss possible solutions to the NEEDS BRIEF, or effectuate other general types of communications, PROPOSED SOLUTION reviews, and/or other activities as may be required and/or desired in a particular embodiment. Often the term NEEDS BRIEF and TECHNICAL TARGET can be used interchangeably.

The NEED owner can also activate and deactivate a NEED. In this regard, when a NEED is activated the TECHNICAL COMMUNITY and/or INVESTOR COMMUNITY can see, review, and respond to the NEEDS BRIEF. When a NEEDS BRIEF is deactivated it is closed and withdrawn from the TECHNICAL COMMUNITY and/or INVESTOR COMMUNITY.

Use of the term “TECHNICAL TARGET” or “TECHNICAL TARGETS”, in the present invention, is intended to mean a technical description of a challenge to be solved. Often the non-technical NEED can be converted into a TECHNICAL TARGET with a technical description that might include, for example and not a limitation, a background of the challenge, desirable attributes of a successful solution, attributes to be avoided in a solution, and perhaps a brief proposal outline, for a respondent to follow. The TECHNICAL TARGET can also include a desired project time frame and budget that the TECHNICAL TARGET, OPPORTUNITY OWNER, may be willing to accept.

In general, a TECHNICAL TARGET originates from a CORPORATE MEMBER and is often assigned to an individual owner, also referred to as an OPPORTUNITY OWNER, who can interact with (anonymously if necessary) members of the TECHNICAL COMMUNITY and/or INVESTOR COMMUNITY, as may be required or desired, to dialog about clarifications of the TECHNICAL TARGET, discuss possible solutions to the TECHNICAL TARGET, or effectuate other general types of communications, PROPOSED SOLUTION reviews, and/or other activities as may be required and/or desired in a particular embodiment.

In practice, a TECHNICAL TARGET often is a well articulated NEED or NEEDS BRIEF and is typically more informational and targeted in description. Preference is to share TECHNICAL TARGETS with the broader TECHNICAL COMMUNITY, while the NEEDS BRIEFS are shared in more intimate settings, like with a smaller group of tech companies or researchers where discussion can lead an informational conversation to help enlighten and convey understanding of the NEEDS BRIEFS more fully.

Use of the term “PROPOSE SOLUTION” or “PROPOSED SOLUTION”, in the present invention, is intended to mean a response in the form of a proposal or other communication of a possible solution to a NEEDS BRIEF or a TECHNICAL TARGET from the TECHNICAL COMMUNITY 118. In general, a PROPOSED SOLUTION is a response from a member of the TECHNICAL COMMUNITY to a challenge whether it is a NEEDS BRIEF or TECHNICAL TARGET.

Use of the term “PORTFOLIO VISUALIZATION”, in the present invention, is intended to mean a series of computer generated reports, lists, charts, graphs, or other informational data presentation from the COMMUNITY LED OPEN INNOVATION 100 system and method data sources. In general, PORTFOLIO VISUALIZATION is a way in which the OPPORTUNITIES, within the COMMUNITY LED OPEN INNOVATION 100 system and method, are organized, and viewed, by way of various computer generated reports, lists, charts, graphs, or other informational data presentation from the COMMUNITY LED OPEN INNOVATION 100 data source as to inform CORPORATE MEMBERS, INVESTOR COMMUNITY MEMBERS, and TECHNICAL COMMUNITY MEMBERS of OPPORTUNITIES and PIPELINE ACTIVITY. In a plurality of exemplary embodiments the OPPORTUNITY data viewable and the types and kinds of data visualization can be tailored for the audience (corporate, investor, technical) and privacy, anonymity, and other factors can be taken into consideration, as may be required and/or desired in a particular embodiment.

With reference to FIG. 2, in an exemplary embodiment, each of the CORPORATE COMMUNITY 102, INVESTOR COMMUNITY 146, and TECHNICAL COMMUNITY 118 can access the COMMUNITY LED OPEN INNOVATION 100 system and method by way of a global network 200 based server 202 having data storage 208 capacities. A global network 200 can be the Internet with data communication access to server 202 and data storage 208. Internet 200 can also be referred to as the cloud, cloud service, software as a service (SaaS), or web enabled.

In an exemplary embodiment, such a COMMUNITY LED OPEN INNOVATION 100 method can be offered and run as a software as a service (SaaS) enterprise solution. In another exemplary embodiment, the COMMUNITY LED OPEN INNOVATION 100 system and method can be operated internally to one or more of the CORPORATE COMMUNITY 102, INVESTOR COMMUNITY 146, or TECHNICAL COMMUNITY 118 members and accessed by the other communities, as may be required and/or desired in a particular embodiment. This type of embodiment might apply well for a technology incubator or accelerator that would like to operate the COMMUNITY LED OPEN INNOVATION 100 system and method and offer access to the platform to a collection of universities, institutes, corporate partners, and investors.

In operation, in an exemplary embodiment, the COMMUNITY LED OPEN INNOVATION 100 system and method resides as a software as a service (SaaS) model and is encoded to execute business logic around several method steps. The method steps can vary in name, number, and function but in this embodiment can be broadly referred to as DEFINING, FINDING, ASSESSING, and ENGAGING.

Use of the term “COMMUNITY FACILITATOR”, in the present invention, is intended to mean an individual or entity that is responsible, in an online manner, to intervene, in the online community, to insure NEEDS BRIEFS, TECHNICAL TARGETS, and other tasks flow into the COMMUNITY LED OPEN INNOVATION 100 system and method, and are processed, reviewed and, as necessary, approved for release to the TECHNICAL COMMUNITY and that PROPOSED SOLUTIONS from the TECHNICAL COMMUNITY 118 flowing back to the CORPORATE COMMUNITY 102 are reviewed and, as necessary, approved by the CORPORATE COMMUNITY 102 to start STATEMENT OF WORK engagements with the TECHNICAL COMMUNITY 118. In addition, the COMMUNITY FACILITATOR 114 ensures that the proper level of security and privacy are maintained for each community member and that each of the CORPORATE COMMUNITY 102, INVESTOR COMMUNITY 146, and TECHNICAL COMMUNITY 118 has the proper PORTFOLIO VISUALIZATION, as to be able to make informed business decisions.

In an exemplary embodiment, the first step of the COMMUNITY LED OPEN INNOVATION 100 system and method can be DEFINING 112A the challenges. In this regard, NEEDS BRIEFS and TECHNICAL TARGETS can be submitted, collected, created, or otherwise harvested from the broader CORPORATE COMMUNITY 102. These NEEDS BRIEFS and TECHNICAL TARGETS can take significant time to vet and clearly articulate the specific challenges that a CORPORATE COMMUNITY 102, CORPORATE MEMBER is seeking capabilities, resources, technologies, or other solutions. This step can also be referred to as harvesting of NEEDS or NEEDS BRIEF or a TECHNICAL TARGET from a CORPORATE MEMBER, wherein the CORPORATE COMMUNITY further comprises a plurality of CORPORATE MEMBERS.

Use of the term “DEFINE” or “DEFINING”, in the present invention, is intended to mean generally a step of determining or otherwise articulating a NEED, NEEDS BRIEF, or TECHNICAL TARGET succinctly, accurately, and sufficiently as to enable members of a TECHNICAL COMMUNITY or INVESTOR COMMUNITY to understand the NEEDS BRIEF or TECHNICAL TARGET, ideally from related, unrelated, and even adjacent industries and fields to be able to offer a PROPOSED SOLUTION in response to the NEEDS BRIEF or TECHNICAL TARGET.

A second step can be to FINDING 112B solutions. In this regard, a decision has been made by an ACCOUNTABILITY BOARD to broadcast or otherwise distribute at least certain of the NEEDS BRIEFS or TECHNICAL TARGETS to the TECHNICAL COMMUNITY 118. The TECHNICAL COMMUNITY 118 can further freely distribute the NEEDS BRIEFS and TECHNICAL TARGETS to their colleagues to try to identify research, capabilities, technologies, or other types and/or kinds of solutions to a specific NEEDS BRIEF or TECHNICAL TARGET challenge.

Use of the term “FIND” or “FINDING”, in the present invention, is intended to mean locating, within the TECHNICAL COMMUNITY, a PROPOSED SOLUTION to a broadcast or otherwise distributed NEEDS BRIEFS or TECHNICAL TARGETS.

Use of the term “ACCOUNTABILITY BOARD”, in the present invention, is intended to mean an advisory board, oversight committee, or steering committee typically inclusive of senior leadership, research fellows, and/or other technical and business leaders at a CORPORATE MEMBER that is accountable for and authorized to at least make decisions as to which of the NEED BRIEFS or TECHNICAL TARGETS to progress from DEFINE to FIND steps and to make decisions as to which of the PROPOSED SOLUTIONS to move from ASSESS 112C to ENGAGE 112D, which can include decisions to initiate a STATEMENT of WORK.

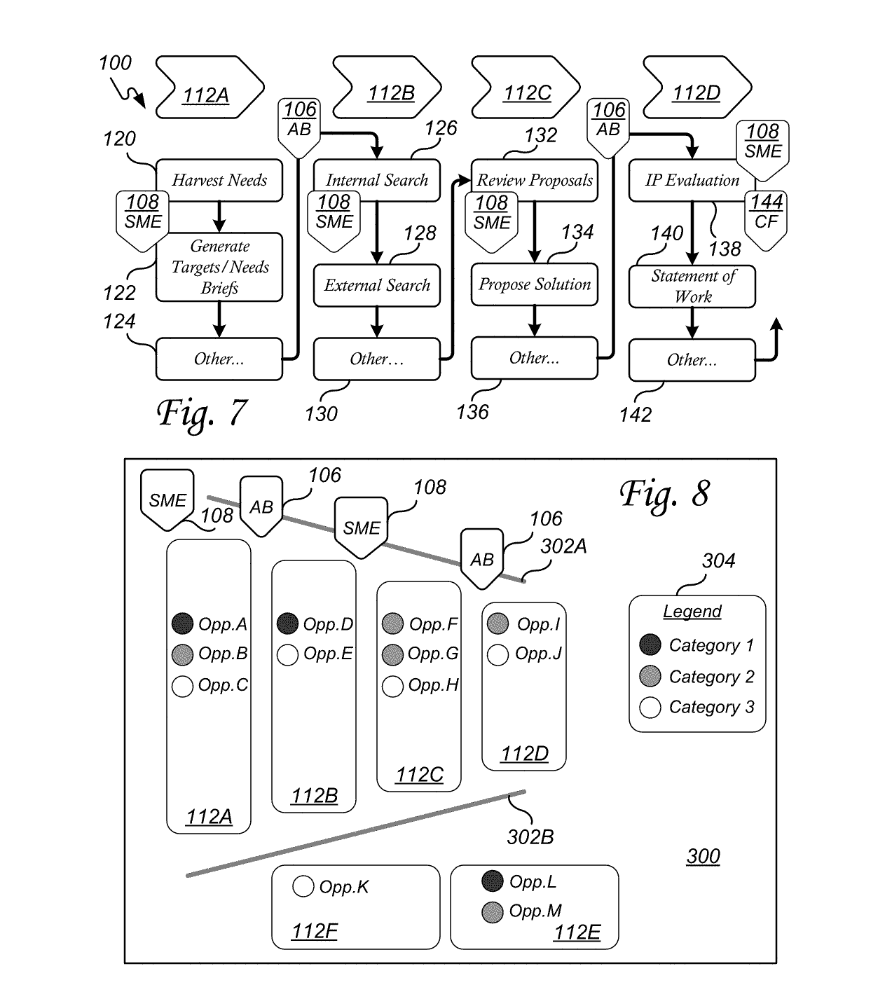

Use of the terms and their intending meaning for “STATEMENT OF WORK” or use of the acronym “SOW”, “EXPLORATION”, “EXPLORATION PROJECT”, “EXPLORATION SOW”, “PILOT”, “PILOT PROJECT”, “PILOT SOW”, “COMMERCIALIZATION”, “COMMERCIALIZATION PROJECT”, or “COMMERCIALIZATION SOW” is further disclosed in at least FIG. 5 and corresponding disclosure below.

A third step can be ASSESSING 112C the PROPOSED SOLUTION(S) which have flowed back into the COMMUNITY LED OPEN INNOVATION 100 system and method from the TECHNICAL COMMUNITY 118 which are responsive to specific NEEDS BRIEFS and/or TECHNICAL TARGETS. The OPPORTUNITY assessing or PROPOSED SOLUTIONS assessing is typically done by the OPPORTUNITY OWNER or SUBJECT MATTER EXPERT associated with the NEEDS BRIEF or TECHNICAL TARGET. Such assessment is typically done to determine among other things suitability of solution to solve the NEED or TECHNICAL TARGET challenge, determining likely terms and conditions required to access or fund an ENGAGEMENT project, and other assessments which can include OPPORTUNITY TECHNICAL READINESS, OPPORTUNITY VALUE, PROBABILITY OF SUCCESS, OPPORTUNITY COMPLEXITY CONFIDENCE LEVEL, and other assessments, as may be required and/or desired in a particular embodiment.

Use of the term “ASSESS” or “ASSESSING”, in the present invention, is intended to mean a technical and business review of the PROPOSED SOLUTIONS. It is also generally referred to the ASSESSING the technical landscape including consumer, business, technical, and competitive insights and trends, as well as, assessing the patent landscape to identify competitive advantaged opportunities, and ideally capturing and patenting the competitive advantaged opportunities by way of patent filings prior to the step of ENGAGING with an external partner.

Use of the term “SUBJECT MATTER EXPERT”, in the present invention, is intended to mean an individual who is a member of a CORPORATE MEMBER within the CORPORATE COMMUNITY, or someone who is relied on and trusted for expert opinion in a particular technical subject matter area by the CORPORATE MEMBER. In general, SUBJECT MATTER EXPERTS are individuals that posses a high level of understand in an area of math, science, engineering, business, or other area and who are frequently relied on for their assessment, understanding, and opinions.

Use of the term “OPPORTUNITY OWNER”, in the present invention, is intended to mean a SUBJECT MATTER EXPERT or other individual or group associated with the CORPORATE MEMBER for which the NEEDS BRIEF or the TECHNICAL TARGET belongs. In this regard, it is the point of contact, within the CORPORATE MEMBER, that is responsible for the NEEDS BRIEFS or TECHNICAL TARGET and will be the point of contact for members of the TECHNICAL COMMUNITY or INVESTOR COMMUNITY when communication from these communities is required and/or desired.

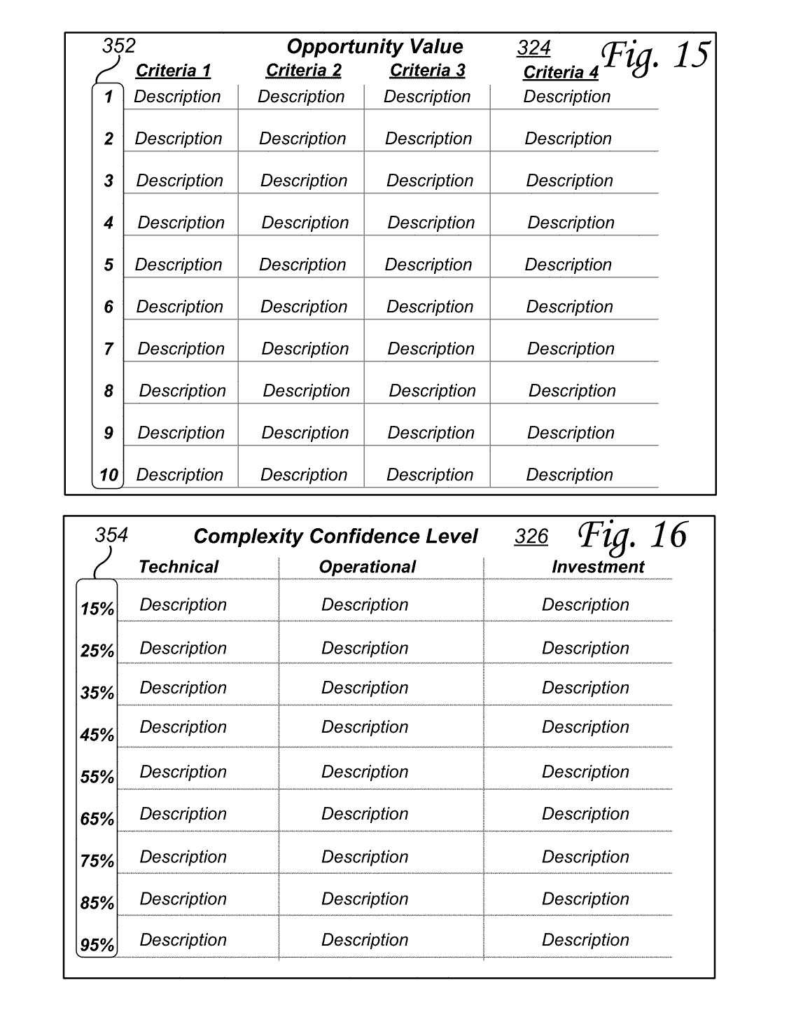

Use of the term “TECHNICAL READINESS”, in the present invention, is intended to mean the ranking of how close an OPPORTUNITY is to COMMERCIAL READINESS on a scale, for example and not a limitation, of one to ten, wherein a TECHNICAL READINESS ranking of a one or two could corresponds to different levels of early stage or discovery stage readiness. A TECHNOLOGY READINESS ranking of a three or four could correspond to different levels of lab scale readiness. A TECHNOLOGY READINESS ranking of a five, six, or seven could correspond to different levels of pilot scale readiness, and a TECHNOLOGY READINESS ranking of eight, nine, or ten could correspond to different levels of commercial readiness. In general, the TECHNOLOGY READINESS ranking is part of a COMMON TECHNOLOGY LANGUAGE to impart as a way of being able to assign, contrast, and compare by a ranking each of a plurality of different PROPOSED SOLUTIONS, STATEMENT OF WORK projects, technologies, solutions, and/or other opportunities. In an exemplary embodiment, the TECHNOLOGY READINESS table illustrated in at least FIG. 14 can be customized for each of the CORPORATE MEMBER, as to adapt to the CORPORATE MEMBER'S specific business needs and environment, as may be required and/or desired in a particular embodiment.

Use of the term “OPPORTUNITY VALUE”, in the present invention, is intended to mean a ranking of business value or positive BUSINESS IMPACT assigned to each of a plurality of OPPORTUNITIES on a scale from low to high. Such ranking can be numerically represented, for example and not a limitation, from one to ten.

The ranking can be assigned more subjectively for early stage OPPORTUNITIES, when business case data is illusive, and then can be updated over time as the OPPORTUNITY progresses towards commercialization and the business cases becomes more validated. In this regard, each OPPORTUNITY can be ranked on the same criteria regardless of development stage which then enables a portfolio view of the different OPPORTUNITIES and an indication of each of OPPORTUNITIES relative positive BUSINESS IMPACT.

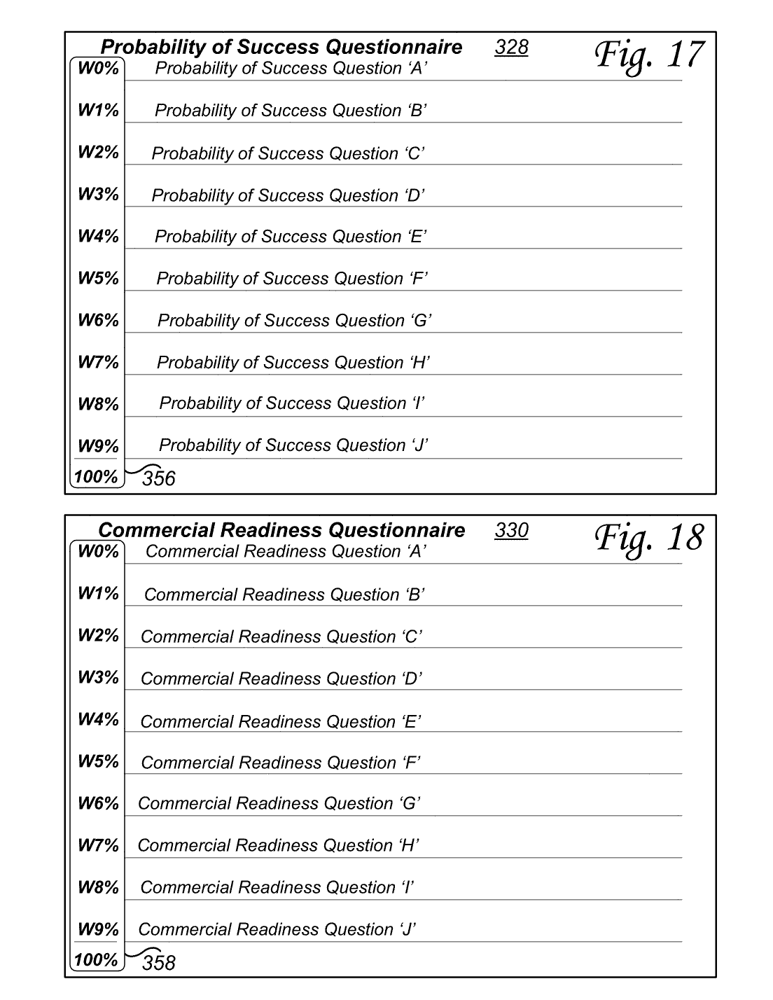

Additionally, OPPORTUNITY VALUE rankings can be assigned based on different criteria as better illustrated in at least FIG. 15, such as, CRITERIA 1, CRITERIA 2, CRITERIA 3, and CRITERIA 4. For example and not a limitation CRITERIA 1 could be ‘New Revenue Generation’ and a dollar range for each value ranking levels can be established from low dollar range ranking a one to high dollar range ranking a ten. CRITERIA 2 could be ‘Increased Volume of Product Sold’ and a range for each value ranking level can be established from low product volume increases ranking a one to high product volume increases ranking a ten. CRITERIA 3 could be ‘Productivity Cost Savings’ where each value ranking level can be established with small cost savings ranking a one to a lot of cost savings ranking a ten. CRITERIA 4 could be ‘Sustainability Goals’ where each ranking level can be established with a small impact on sustainability goals ranking a one to a big impact on sustainability goals ranking a ten. In this regard, each OPPORTUNITY can be ranked based on the best CRITERIA match for the OPPORTUNITY and thus represent the business value or the positive BUSINESS IMPACT the OPPORTUNITY can have on the business. In an exemplary embodiment, the OPPORTUNITY table illustrated in at least FIG. 15 can be customized for each of the CORPORATE MEMBER, as to adapt to the CORPORATE MEMBER'S specific business needs and environment, as may be required and/or desired in a particular embodiment.

Use of the term “PROBABILITY OF SUCCESS”, in the present invention, is intended to mean the probability that a NEEDS BRIEF, TECHNICAL TARGET, PROPOSED SOLUTION, STATEMENT OF WORK, collectively also referred to as an OPPORTUNITY will reach a TECHNICAL READINESS ranking of at least being ready for commercialization. Reaching commercial readiness indicates that a ‘technical success’ has been achieved and that the technology is ready to be commercialized.

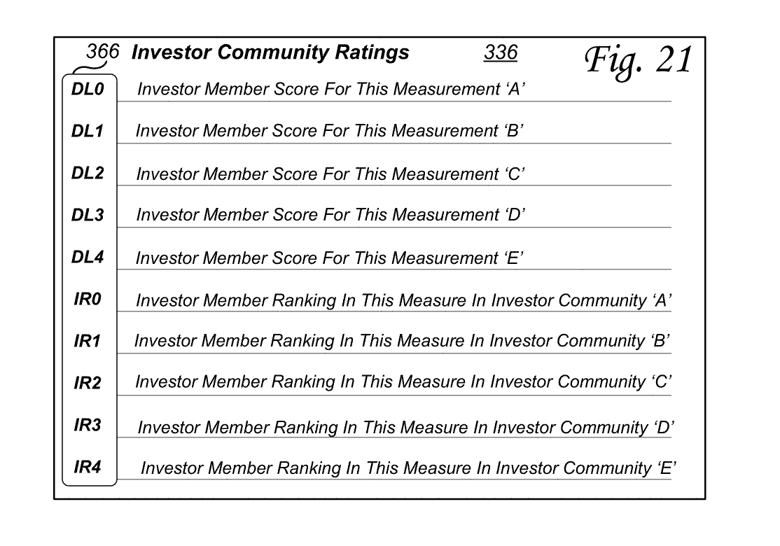

In an exemplary embodiment, the PROBABILITY OF SUCCESS for each of an OPPORTUNITY can be determined through a PROBABILITY OF SUCCESS questionnaire, such as better illustrated in at least FIG. 17 and corresponding disclosure.

In another exemplary embodiment, the PROBABILITY OF SUCCESS can be determined through an analytical method and/or by way of a hybrid analytical method and questionnaire method, as may be required and/or desired in a particular embodiment.

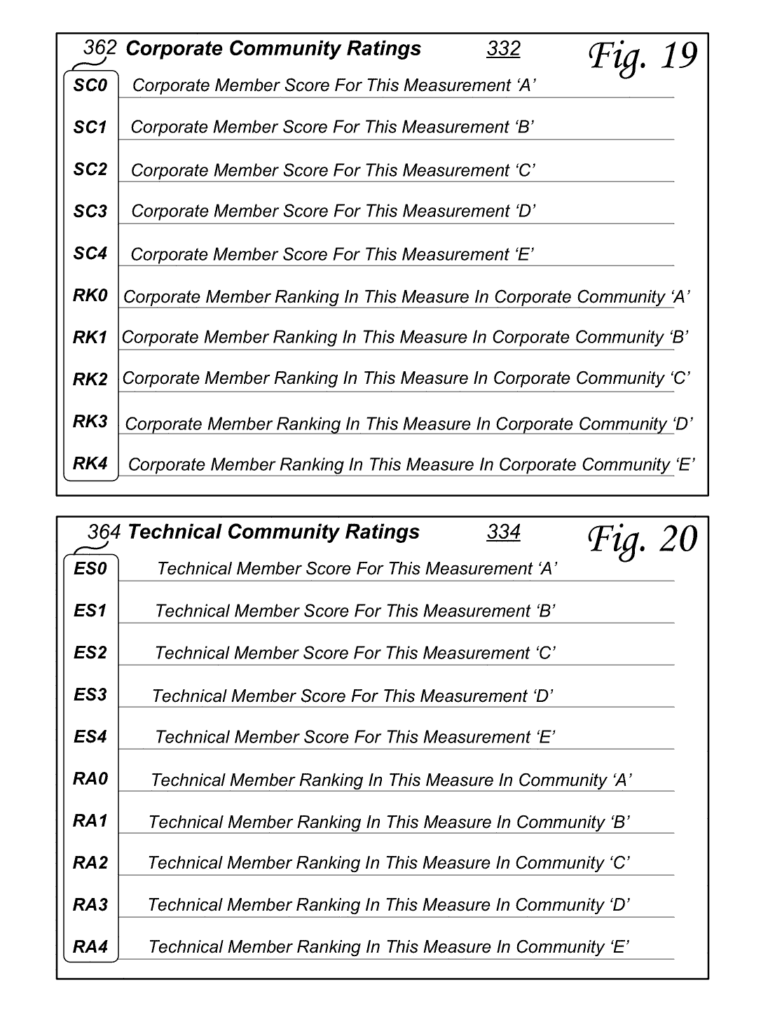

Since there are almost always extraneous circumstances, broadly categorized as ‘technical complexities’, ‘operational complexities’, and ‘investment complexities’ such as access to capital, suitability and availability of facilities, supply chain capacities, and numerous others factors that can influence the PROBABILITY OF SUCCESS, from a macro perspective, a more accurate reflection of the true PROBABILITY OF SUCCESS can better be determined by multiplying the PROBABILITY OF SUCCESS by the OPPORTUNITY COMPLEXITY CONFIDENCE LEVEL which can be determined, in a preferred embodiment, by way of a lookup table as illustrated in at least FIG. 16 and corresponding disclosure. Noting that in other embodiments other methods to determine the OPPORTUNITY COMPLEXITY CONFIDENCE LEVEL can be employed.

Use of the term “OPPORTUNITY COMPLEXITY CONFIDENCE LEVEL” or “COMPLEXITY CONFIDENCE LEVEL”, in the present invention, is intended to mean a probability confidence level that takes into consideration ‘technical complexity’, ‘operational complexity’, and ‘investment complexity’ such as capital, facility, capacity, and other factors that can be assigned to each of the OPPORTUNITIES. In this regard, for example and not a limitation, and as better illustrated in at least FIG. 16, the OPPORTUNITY COMPLEXITY CONFIDENCE LEVEL can range from as low as 1% to as high as 100% guided by a lookup table of descriptions that can be used to adjust the PROBABILITY OF SUCCESS based, in part, on the complexity associated with ‘technical complexity’ risk, ‘operational complexity’ risk, ‘investment complexity’ risk, and other complexity risk of the OPPORTUNITY being developed.

In an exemplary embodiment, as example and not a limitation, lower confidence level ratings can be assigned, perhaps less than 40% if a technical solution has never been done before or if operationally payback is greater than five years. Additionally, a mid level confidence rating between 40% and 70% can be assigned if some technical or operation hurdles will require outside resources, investment to launch is average, or payback is in the three year range. Furthermore, a high level confidence rating between 70% and 95%+ can be assign when no technical or operation hurdles remain in the project and investment for launch is minimal or has been secured.

In this regard, the PROBABILITY OF SUCCESS (Psuccess_adjusted) becomes the adjusted product of the weighted determined PROBABILITY OF SUCCESS (Psuccess_questionaire) multiplied by the OPPORTUNITY COMPLEXITY CONFIDENCE LEVEL (Confidence Level).

Psuccess_{adjust}=ConfidenceLevel·Psuccess_{questionnaire}

In general, as projects progress and hurdles and obstacles change so to should the OPPORTUNITY COMPLEXITY CONFIDENCE LEVEL rating. In an exemplary embodiment, the OPPORTUNITY COMPLEXITY CONFIDENCE LEVEL table illustrated in at least FIG. 16 can be customized for each of the CORPORATE MEMBER, as to adapt to the CORPORATE MEMBER'S specific business needs and environment, as may be required and/or desired in a particular embodiment.

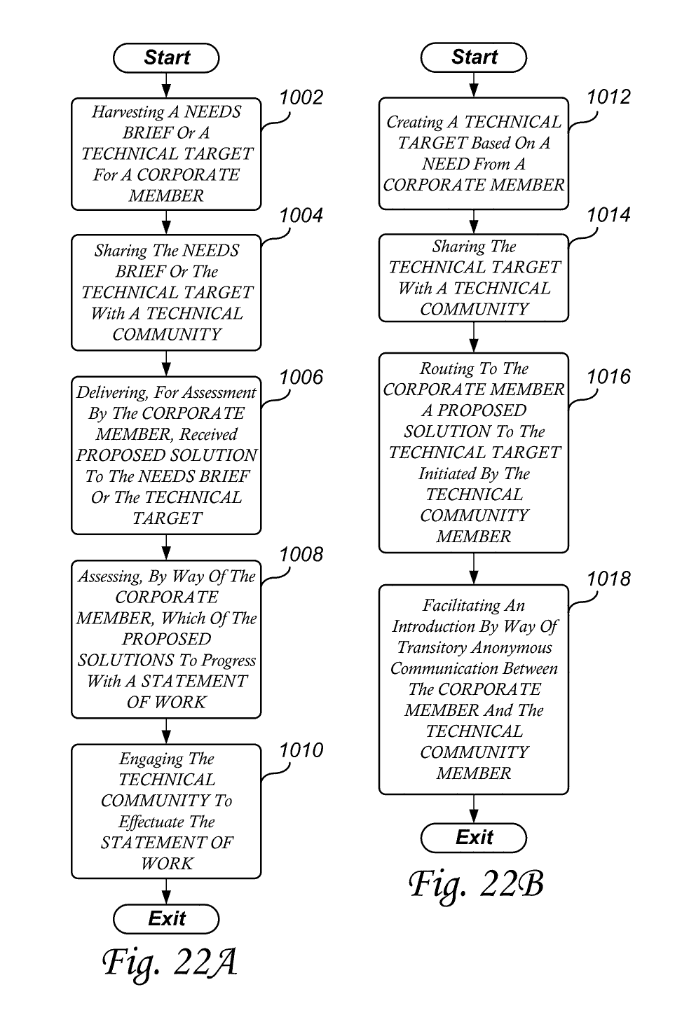

Use of the term “COMMERCIAL READINESS”, in the present invention, is intended to mean the status of an OPPORTUNITY'S readiness to be commercialized. Differing from TECHNICAL READINESS in that TECHNICAL READINESS is focused on the technology reaching a readiness state to be commercialized, whereas COMMERCIAL READINESS is focused on the organization's or CORPORATE MEMBER'S readiness to move the technology from research and development to a commercial market execution. In this regard, in an exemplary embodiment, COMMERCIAL READINESS can be determined through a questionnaire comprising MATHEMATICALLY WEIGHTED QUESTIONS, such as better illustrated in at least FIG. 18. Such a questionnaire can prompt a series of questions related to commercialization risks like “Is there a commitment to commercialize?”, “Has a successful pilot be completed?”, “Has the concept been tested with consumers?”, “Has a commercialization plan been developed?”, and other types and kinds of questions, each of which can be mathematically weighted such that as the questions are answered in the affirmative the COMMERCIAL READINESS percentage increases. In an exemplary embodiment, the MATHEMATICALLY WEIGHTED QUESTIONS illustrated in at least FIG. 18 can be customized for each of the CORPORATE MEMBER, as to adapt to the CORPORATE MEMBER'S specific business needs and environment, as may be required and/or desired in a particular embodiment.

In another exemplary embodiment, the COMMERCIAL READINESS can be determined through an analytical method and/or by way of a hybrid analytical method and questionnaire method, as may be required and/or desired in a particular embodiment.

Use of the term “MATHEMATICALLY WEIGHTED QUESTION”, in the present invention is intended to mean a question that has been assigned a contributing percentage, probability, or other value. In this regard, when answered in the affirmative the contributing percentage, probability, or other value accrues and through a series of MATHEMATICALLY WEIGHT QUESTIONS an indication of a state or condition becomes more understandable. Such a state or condition can be COMMERCIAL READINESS of an OPPORTUNITY or the PROBABILITY OF SUCCESS of an OPPORTUNITY. As an example, if COMMERCIAL READINESS of an OPPORTUNITY was measured by the MATHEMATICALLY WEIGHTED QUESTIONS, “Has a success pilot be completed” weighted by 45% and the MATHEMATICALLY WEIGHTED QUESTION “Has a customer ordered a unit” weighted by 45%, the COMMERCIAL READINESS of the OPPORTUNITY could be considered 90% ready for commercialization. In an exemplary embodiment, the MATHEMATICALLY WEIGHTED QUESTIONS can be customized for each of the CORPORATE MEMBER, as to adapt the questionnaire to the CORPORATE MEMBER'S specific business needs and environment, as may be required and/or desired in a particular embodiment.

Use of the term “COMMON TECHNOLOGY LANGUAGE”, in the present invention, is intended to mean a series of mechanisms and ranking schemes to assign a TECHNOLOGY READINESS, OPPORTUNITY VALUE, PROBABILITY OF SUCCESS, OPPORTUNITY COMPLEXITY CONFIDENCE LEVEL, and other relevant metrics to each of a plurality of OPPORTUNITIES, to establish a language which describes each of the OPPORTUNITIES so that cross-functionally from Sales and Marketing, to Business Development, to Customer Teams, to Finance and Legal, to Technical, and with other parts of the business and customer relationship, each know the exact state, stage, risks, value, readiness, investment needed, and other metrics to reach COMMERCIAL READINESS of a particular OPPORTUNITY. In this regard, with a COMMON TECHNOLOGY LANGUAGE to discuss the status of OPPORTUNITIES more accurate and informed business decisions can be made across all functions and with customers, de-risking the pathway to commercialization, and aligning OPPORTUNITIES more quickly with business goals and objectives.

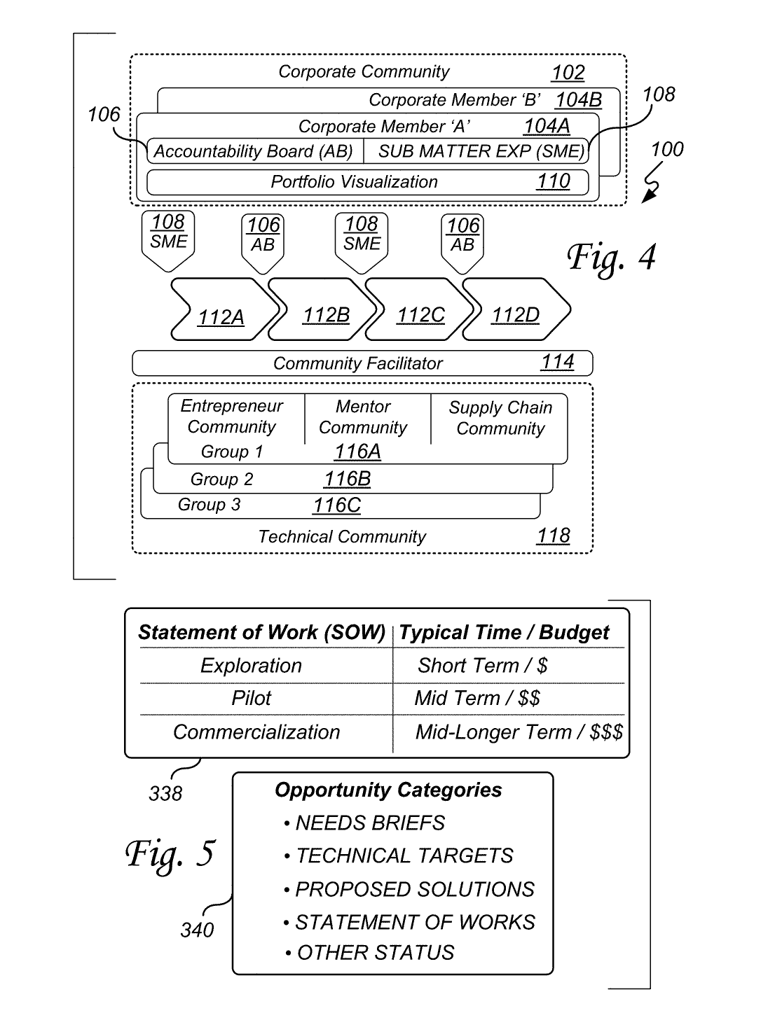

Referring to FIG. 3 there is illustrated one example of an OPPORTUNITY flowing through the COMMUNITY LED OPEN INNOVATION 100 system and method. Building on the COMMUNITY LED OPEN INNOVATION 100 system and method of at least FIG. 2, FIG. 3 traces in more detail an OPPORTUNITY path 342 through the system and method 100. In an exemplary embodiment, a CORPORATE MEMBER ‘A’ 104A has previously established an ACCOUNTABILITY BOARD (AB) 106 and a SUBJECT MATTER EXPERT (SME) 108 who can act as an OPPORTUNITY OWNER of the NEEDS BRIEF or TECHNICAL TARGET and also serve as technical assessor of PROPOSED SOLUTIONS, as well as, STATEMENT OF WORK initiator. In this exemplary embodiment, denoted by the SUBJECT MATTER EXPERT (SME) 108 paddle positioned prior to the step of DEFINING 112A, the SME 108 initiates the COMMUNITY LED OPEN INNOVATION 100 system and method by providing a NEEDS BRIEF or a TECHNICAL TARGET 344 which enters the step of DEFINING 112A. Often refinement of a NEEDS BRIEF or TECHNICAL TARGET is necessary to make it read generically or anonymously to protect the identity of the CORPORATE MEMBER seeking the solution. Also refinement can include making sure the NEEDS BRIEF or TECHNICAL TARGET is non-confidential so it can be freely be distributed publically.

In this exemplary embodiment, after a NEEDS BRIEF or TECHNICAL TARGET 344 has been defined and prior to the advancement to the step of FINDING 112B and any external communication, denoted by the ACCOUNTABILITY BOARD (AB) 106 paddle positioned between the steps of DEFINING 112A and FINDING 112B, the ACCOUNTABILITY BOARD 106 has an opportunity to review and approve the NEEDS BRIEF or TECHNICAL TARGET for broadcast to the TECHNICAL COMMUNITY. A series of PORTFOLIO VISUALIZATION 110 reports and tools are available to generate the holistic view of the CORPORATE MEMBER'S portfolio for the ACCOUNTABILITY BOARD 106 to review, decide, and/or otherwise sponsor the broadcasting of the NEEDS BRIEF or TECHNICAL TARGET.

Once approved by the ACCOUNTABILITY BOARD 106 the NEEDS BRIEF or TECHNICAL TARGET move to the step of FINDING 112B and the NEEDS BRIEF or TECHNICAL TARGET is broadcast to the TECHNICAL COMMUNITY where it is disseminated, reviewed, and PROPOSED SOLUTIONS 360 are generated. The PROPOSED SOLUTIONS are returned to the system and method step of FINDING 112B where the SME 108 can interact with the PROPOSED SOLUTION and, as required, interact with the submitter of the PROPOSED SOLUTION, from the TECHNICAL COMMUNITY 118, anonymously if necessary, to refine or better understand the PROPOSED SOLUTION. Denoted by the SME 108 paddle positioned between the steps of FINDING 112B and ACCESSING 112C, once satisfied the SME 108 decides whether to move the PROPOSED SOLUTION to the step of ASSESSING 112C.

As this exemplary embodiment continues, in the step of ASSESSING 112C the SME 108 and others can assess the PROPOSED SOLUTION on technical merits, feasibility, likelihood of success, fit for use, business or strategic objectives, and other merits, as may be required and/or desired in a particular embodiment. In addition, the SME 108 can work with Legal, Regulatory, and other functions to insure the PROPOSED SOLUTION is patent protectable or has freedom to operate, or meets other Legal function requirements and that the PROPOSED SOLUTION meets any regulatory requirements or at least the regularly requirement and landscape are sufficiently understood. Once the SME 108 feels the PROPOSED SOLUTION is ready and worthy of advancement, the PORTFOLIO VISUALIZATION 110 reports and tools can be utilized to again seek ACCOUNTABILITY BOARD 106 review, and approval of the PROPOSED SOLUTION to advance to the next step.

Denoted by the AB 106 paddle positioned between the steps of ASSESSING 112C and ENGAGING 112D, once approved by the ACCOUNTABILITY BOARD 106, the PROPOSED SOLUTION then moves into the step of ENGAGING 112 where the external partner is engaged through a STATEMENT OF WORK 368 to perform technical services associated with the PROPOSED SOLUTION. Such STATEMENT OF WORK can include EXPLORATION PROJECTS, PILOT PROJECTS, or COMMERCIALIZATION PROJECTS, as appropriate.

In an exemplary embodiment, it can be common that once a STATEMENT OF WORK project has been completed that the OPPORTUNITY returns to the appropriate step in the COMMUNITY LED OPEN INNOVATION 100 system and method and a new PROPOSED SOLUTION for a next phase of work be developed and approved through the same method steps. As example and not a limitation, once a SOW for an EXPLORATION project is concluded the results can be returned as a new PROPOSED SOLUTION to the ASSESSING 112C step for SME 108 and ACCOUNTABILITY BOARD 106 to review and approve to move to the next phase of SOW for a PILOT PROJECT. As another example and not a limitation, after reviewing PROPOSED SOLUTIONS, for a TECHNICAL CHALLENGE, the SME may decide that the TECHNICAL CHALLENGE may need to be articulated differently or more clearly. As a result, the SME may return to the step of DEFINING 112A and redraft the TECHNICAL TARGET and have the ACCOUNTABILITY BOARD 106 reapproved for external search the TECHNICAL TARGET in the TECHNICAL COMMUNITY 118 to try to get different types of PROPOSED SOLUTIONS. In general, NEEDS BRIEFS, TECHNICAL TARGETS, PROPOSED SOLUTIONS, SOW projects, and OPPORTUNITIES in general can be evaluated, stopped, completed, and returned to any step of the COMMUNITY LED OPEN INNOVATION 100 system and method, as may be required in a particular embodiment and on an OPPORTUNITY by OPPORTUNITY basis.

At any point in the COMMUNITY LED OPEN INNOVATION 100 system and method the SME 108 and/or the ACCOUNTABILITY BOARD 106 can stop a NEEDS BRIEF, TECHNICAL TARGET, or PROPOSED SOLUTION from advancing. In addition, during the step of ENGAGING 112D where STATEMENT OF WORKS are being executed and external partners are working on solutions, these STATEMENTS OF WORK and the associated projects can be reported out to the ACCOUNTABILITY BOARD periodically and intervention including changing the scope of work, funding, or termination of the project can be effectuated by the ACCOUNTABILITY BOARD.

For clarity, in this exemplary embodiment the COMMUNITY LED OPEN INNOVATION system and method can be implemented in online software as a service (SaaS) environment where most everything happens in an online community format. In this regard, terms like broadcasting to the TECHNICAL COMMUNITY and PROPOSED SOLUTIONS being returned to the COMMUNITY LED OPEN INNOVATION 100 system and method are all handled in an online communication format where real time and portfolio views are always available and utilized to track the activity of each of the OPPORTUNITIES moving through the system and method. It is noted that throughout this specification such terms are to be construed as largely taking place within and online community.

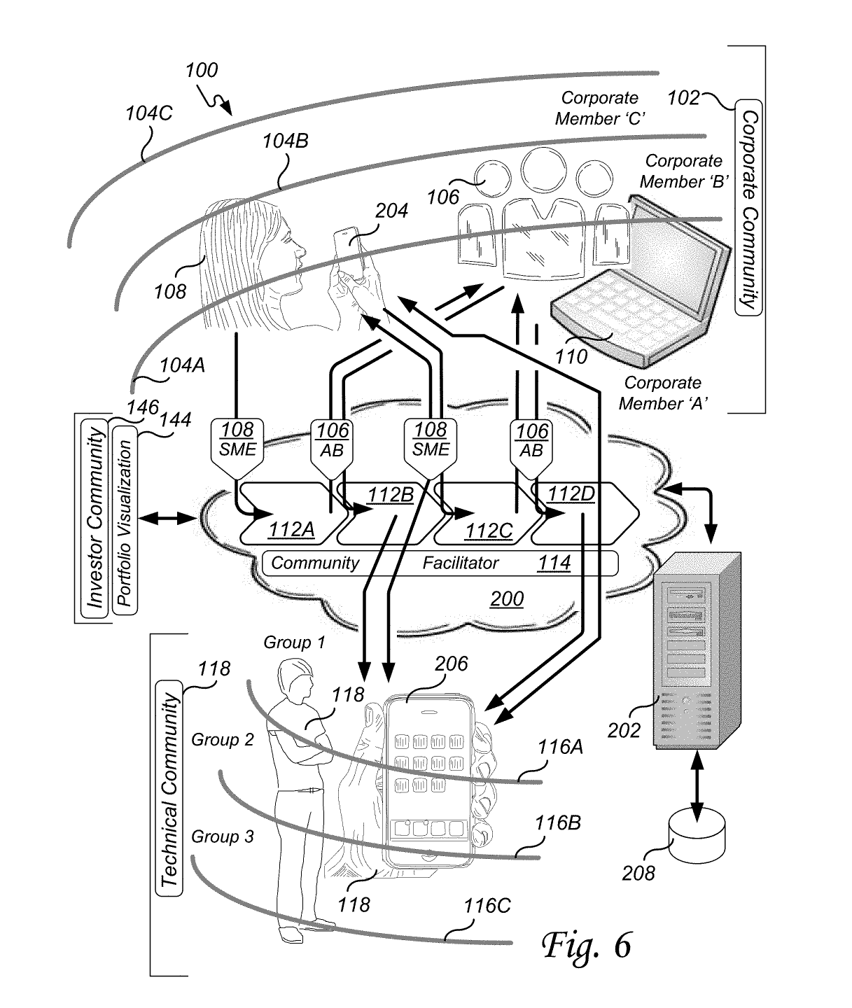

Referring to FIG. 4 there is illustrated one example of a COMMUNITY LED OPEN INNOVATION 100 organizational layout. Building out further the COMMUNITY LED OPEN INNOVATION 100 system and method of FIGS. 2 and 3, FIG. 4 further details the organizational structure of the COMMUNITY LED OPEN INNOVATION 100 system and method. In this regard, in an exemplary embodiment for example ant not a limitation, a CORPORATE COMMUNITY 102 can comprise each of a plurality of CORPORATE MEMBER ‘A’ 104A, CORPORATE MEMBER ‘B’ 104B, and other CORPORATE MEMBERS; a count that is not limited. As illustrated for CORPORATE MEMBER ‘A’ 104A, each of the CORPORATE MEMBERS can organizationally further comprise at least an ACCOUNTABILITY BOARD (AB) 106 group and a SUBJECT MATTER EXPERT (SME) 108 group. These groups, unique to each CORPORATE MEMBER, typically comprise senior leadership, research fellows, and other experts who are employees or associates of the CORPORATE MEMBER. For clarity, in an exemplary embodiment, each CORPORATE MEMBER can appoint an ACCOUNTABILITY BOARD and SUBJECT MATTER EXPERT group.

In an exemplary embodiment, denoted by the SME 108 paddle positioned prior to the step of DEFINING 112A, the SME 108 group approves and initiates the step of DEFINING 112A with the introduction of NEEDS BRIEFS and/or TECHNICAL TARGETS. This step can also be referred to as harvesting a NEEDS BRIEF or a TECHNICAL TARGET from a CORPORATE MEMBER, wherein the CORPORATE COMMUNITY further comprises a plurality of the CORPORATE MEMBERS.

Denoted by the AB 106 paddle positioned between DEFINING 112A and 112B, the AB 106 reviews and approves the initiation of the step of FINDING 112B. Once approved, the NEEDS BRIEF and/or TECHNICAL TARGET are broadcast to the TECHNICAL COMMUNITY 118. This step can also be referred to as sharing the NEEDS BRIEF or the TECHNICAL TARGET with a TECHNICAL COMMUNITY and/or delivering, for assessment by the CORPORATE MEMBER, received PROPOSED SOLUTION to the NEEDS BRIEF or the TECHNICAL TARGET from the TECHNICAL COMMUNITY.

Denoted by the SME 108 paddle positioned between step FINDING 112B and ASSESSING 112C, the SME 108 group approves the PROPOSED SOLUTION to move to the step of ASSESSING 112C wherein the PROPOSED SOLUTIONS are vetted and refined. This step can also be referred to as reviewing, assessing, and determining, by way of the CORPORATE MEMBER, which of the PROPOSED SOLUTION to progress with a STATEMENT OF WORK in the COMMUNITY LED OPEN INNOVATION 100 system and method.

Denoted by the AB 106 paddle positioned between the step ASSESSING 112C and ENGAGING 112D, the AB 106 group approves the movement of the PROPOSED SOLUTIONS to the step of ENGAGING 112D, wherein a STATEMENT OF WORK is created around the PROPOSED SOLUTION to be executed and fulfilled in the TECHNICAL COMMUNITY 118. This can also be referred to as engaging the TECHNICAL COMMUNITY to effectuate the STATEMENT OF WORK.

In an exemplary embodiment a COMMUNITY FACILITATOR 114 can administer the COMMUNITY LED OPEN INNOVATION 100 system and method insuring the timeliness and communication flow between the CORPORATE COMMUNITY 102 and the TECHNICAL COMMUNITY 118 continue unabated. The COMMUNITY FACILITATOR 114 also can ensure the PORTFOLIO VISUALIZATION 110 reports, charts, and presentations are ready for the SME 106 and AB 108 review and approval sessions.

In this exemplary embodiment, the TECHNICAL COMMUNITY 118 can comprise a plurality of different GROUPS illustrated as GROUP 1, GROUP 2, and GROUP 3. Any number of groups can be part of the TECHNICAL COMMUNITY 118. Each of the ‘GROUP 1’ 116A, ‘GROUP 2’ 116B, and ‘GROUP 3’ 116C can further comprise an ENTREPRENEUR COMMUNITY, a MENTOR COMMUNITY, and a SUPPLY CHAIN COMMUNITY.

Use of the term “ENTREPRENEUR” or “ENTREPRENEUR COMMUNITY”, in the present invention, is intended to mean an individual, Startup Company, accelerator team, technology incubator residents, researchers, scientists, engineers, business entity, organization, non-profit organization, and others who believe they can solve a challenge articulated in a NEEDS BRIEF or TECHNICAL TARGET individually or in collaboration with others.

Use of the term “MENTOR” or “MENTOR COMMUNITY”, in the present invention, is intended to mean individuals or organizations that offer mentoring, coaching, or advice to the ENTREPRENEUR, and/or ENTREPRENEUR COMMUNITY. Such MENTORS can be retired professional and executives from the group of CORPORATE MEMBERS. In this regard, retirees from CORPORATE MEMBERS are in the unique position of being able to help the ENTREPRENEURS better understand the NEEDS and business context of a solution intended for a particular CORPORATE MEMBER. This can save much time and making the PROPOSED SOLUTION more relevant to the CORPORATE MEMBER. Other MENTORS can be Entrepreneurs in Residence at accelerators and technology incubators, Angel Investors with prior successful backgrounds, and others, as may be required and/or desired in a particular embodiment.

Use of the term “SUPPLIER”, “SUPPLIER COMMUNITY”, or “SUPPLY CHAIN COMMUNITY”, in the present invention, is intended to mean supply chain partners who can collaborate and/or partner with the ENTREPRENEURS and/or the MENTORS to provide commercial pathway and commercialization know how, expertise, and services; even partnerships for commercialization, installation, and service. In this regard, many CORPORATE PARTNERS control market access but rely on SUPPLY CHAIN PARTNERS to deliver solutions to their supply chains. As such, collaborating or partnering with the CORPORATE MEMBER'S chosen SUPPLIER can more rapidly move the ENTREPRENEUR'S solution to market on a known commercial pathway, by way of the SUPPLY CHAIN PARTNERS.

In an exemplary embodiment, once the step of ENGAGING 112D is approved and a subsequent STATEMENT OF WORK is contemplated, pairing the ENTREPRENEUR'S PROPOSED SOLUTION with a MENTOR and a SUPPLY CHAIN PARTNER can greatly increase the likelihood of success. As each of the CORPORATE MEMBER, ENTREPRENEUR, MENTOR, and SUPPLIER can be essential pieces and partners to an overall solution. As such, collaborating together can increase the PROBABILITY OF SUCCESS and speed COMMERCIAL READINESS of the OPPORTUNITY.

In an exemplary embodiment and for clarity, each of the CORPORATE MEMBERS 104A and 104B and the TECHNICAL COMMUNITY 118 GROUPS 116A, 116B, and 116C can be mutually exclusive and portfolios, data, and activity for each can be sequestered from the other community members to maintain the right level of privacy, security, and anonymity of the members, as may be required and/or desired in a particular solution. Furthermore, in this regard, the PORTFOLIO VISUALIZATION 110 of each CORPORATE MEMBER 104A and 104B and the TECHNICAL COMMUNITY 118 GROUPS 116A, 116B, 116C, and 116D can be private, secured, and remain confidential from the respective member or group owning the content, as may be required and/or desired in a particular embodiment.

Referring to FIG. 5 there is illustrated examples of STATEMENT OF WORKS 338 and OPPORTUNITY 340 categories. In an exemplary embodiment, STATEMENT OF WORKS can be utilized to start at least three kinds of projects EXPLORATION, PILOT, and COMMERCIALIZATION. In other exemplary embodiments other types, kinds, and number of project types can be initiated, as may be required and/or desired in a particular embodiment.

Use of the term “STATEMENT OF WORK” or use of the acronym “SOW”, in the present invention, is intended to me an agreement for agreed technical services or deliverables, over some duration of time, at some agreed budget, and often including some milestones or performance criteria. In general, as an example and not a limitation, for purposes of the present invention, STATEMENT OF WORKS can be categorized into three types EXPLORATION projects, PILOT projects, and COMMERCIALIZATION projects.

Use of the term “EXPLORATION”, “EXPLORATION PROJECT”, or “EXPLORATION SOW”, in the present invention, is intended to mean a short-term, typically less than six month engagement, at low to moderate cost to prove a technical capability of an OPPORTUNITY or to accomplish a demonstration. Perhaps the deliverable being to produce a video or presentation highlighting the capability of the technology; something that can serve as the basis to communicate internally within a CORPORATE MEMBER to build project awareness, prove business need or value, seek sponsorship for further project work, or for other purposes, as may be required and/or desired in a particular embodiment.

Use of the term “PILOT”, “PILOT PROJECT”, or “PILOT SOW”, in the present invention, is intended to mean a mid-term, typically less than twelve month engagement, at mid to high cost to develop and test a technology in a pilot or proof-of-concept environment. Such deliverables provide technical validation, perhaps first install, and customer or consumer interaction and feedback, and/or other deliverables, as may be required and/or desired in a particular embodiment.

Use of the term “COMMERCIALIZATION”, “COMMERCIALIZATION PROJECT”, or “COMMERCIALIZATION SOW”, in the present invention, is intended to mean a project of potentially longer term and higher cost focused on commercialization of an OPPORTUNITY. Such deliverables often providing design for manufacture, supplier relationships, inventory supply build up, functional testing, and safety and compliance testing, and documentation creation, among other things. Generally speaking, the goal of a COMMERCIALIZATION PROJECT is to make a market approach and seek to enter a market with a product offering or service.

In an exemplary embodiment, OPPORTUNITY 340 categories can include NEEDS BRIEFS, TECHNICAL TARGETS, PROPOSED SOLUTIONS, STATEMENT OF WORKS, and/or other types and kinds of categories, as may be required and/or desired in a particular embodiment. In this regard, each of the OPPORTUNITY categories, within the COMMUNITY LED OPEN INNOVATION 100 system and method steps of DEFINING 112A, FINDING 112B, ASSESSING 112C, and ENGAGING 112D, can be referred to as OPPORTUNITIES. For clarity the NEEDS BRIEFS and TECHNICAL TARGET typically associated with steps of DEFINING 112A and FINDING 112B can be referred to as OPPORTUNITIES. In addition, the PROPOSED SOLUTIONS typically associated with steps of FINDING 112B and ASSESSING 112C and ENGAGING 112D can be referred to as OPPORTUNITIES. Furthermore, the STATEMENT OF WORKS typically associated with the step of ENGAGING 112D can be referred to as OPPORTUNITIES. One purpose for this nomenclature is to be able to show PORTFOLIO VISUALIZATIONS in reports, charts, and otherwise of the OPPORTUNITIES (inclusive of all types of activity) in the ACTIVITY PIPELINE, also referred to as the steps of the COMMUNITY LED OPEN INNOVATION 100 system and method.

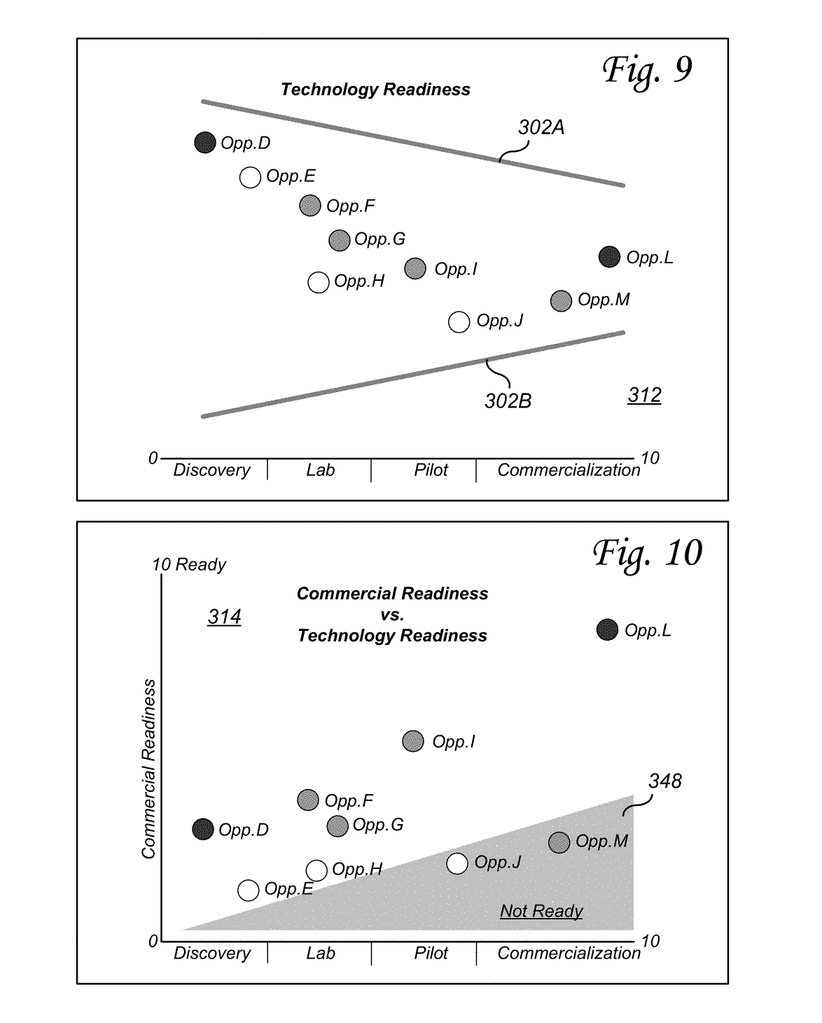

Referring to FIG. 6 there is illustrated one example of community members interacting over a global network utilizing the COMMUNITY LED OPEN INNOVATION 100 system and method. In an exemplary embodiment, a global network 200 can be the Internet and the arrow flowing through the cloud 200 and steps of DEFINING 112A, FINDING 112B, ASSESSING 112C, and ENGAGING 112D indicate how an OPPORTUNITY can move through the COMMUNITY LED OPEN INNOVATION 100 system and method. For clarity the COMMUNITY LED OPEN INNOVATION 100 system and method are illustrated as residing in the cloud 200. In actuality the COMMUNITY LED OPEN INNOVATION 100 system can be operated over a global network 200 utilizing a COMMUNITY FACILITATOR 114, in an online community format. This approach and an objective of utilizing a COMMUNITY FACILITATOR 114 is to facilitate the cloud based COMMUNITY LED OPEN INNOVATION 100 system and method to drive a significant increase in the adoption rate of new technologies, technical resources, and technical capabilities, broadly referred to as OPPORTUNITIES, into the CORPORATE COMMUNITY from a TECHNICAL COMMUNITY.

The COMMUNITY LED OPEN INNOVATION 100 system and method comprises a server 202, which further comprises a data storage memory 208, the data storage memory 208 can be encoded with instructions which when executed perform the steps of the COMMUNITY LED OPEN INNOVATION 100 system and method. The COMMUNITY LED OPEN INNOVATION can be global network 200 based and accessible as a cloud service also referred to as a SaaS model.

In this regard, in an exemplary embodiment, for example and not a limitation, a SUBJECT MATTER EXPERT (SME) 108 creates a NEEDS BRIEF or a TECHNICAL TARGET. Such a NEEDS BRIEF or TECHNICAL TARGET can be created using a digital device 204, which can be a wireless or smart phone, a tablet, a laptop, or other digital device. The arrow illustrates that the NEEDS BRIEF or TECHNICAL TARGET upon approval by the SME 108, denoted by the paddle positioned prior to the step of DEFINING 112A, enters the step of DEFINING 112A. This step can also be referred to as harvesting a NEEDS BRIEF or a TECHNICAL TARGET from a CORPORATE MEMBER, wherein the CORPORATE COMMUNITY further comprising a plurality of the CORPORATE MEMBER illustrated as division lines 104A, 104B, and 104C.

The SME 108 approved NEEDS BRIEF or TECHNICAL TARGET is then routed to the ACCOUNTABILITY BOARD (AB) 106, denoted by the paddle positioned between the steps of DEFINING 112A and FINDING 112B. The AB 106 can utilize PORTFOLIO VISUALIZATION 110 reports, charts, and tools online by way of digital device 110, which can be a wireless or smart phone, tablet, laptop of other digital devices, to evaluate the request and decide to approve or reject the request to broadcast the NEEDS BRIEF or TECHNICAL TARGET. Should the AB 106 approve for broadcast the NEEDS BRIEF or TECHNICAL TARGET moves to the step of FINDING 112B and can be broadcast or otherwise disseminated to the TECHNICAL COMMUNITY 118 where it can be viewed and responded to by way of TECHNICAL COMMUNITY MEMBER'S digital device 206, which can be a wireless or smart phone, tablet, laptop, or other digital devices. This step can also be referred to as sharing the NEEDS BRIEF or the TECHNICAL TARGET with the TECHNICAL COMMUNITY and/or delivering, for assessment by the CORPORATE MEMBER, received PROPOSED SOLUTION to the NEEDS BRIEF or the TECHNICAL TARGET from the TECHNICAL COMMUNITY.

Conversations and other communications, anonymously if desired, can be effectuated between the SME 108 who is the OPPORTUNITY OWNER of the NEEDS BRIEF and TECHNICAL TARGET that is being responded to by the TECHNICAL COMMUNITY MEMBER 118. In this regard, clarity and questions can be asked and answered and the SME 108 and the TECHNICAL COMMUNITY MEMBER 118 can collaborate on a PROPOSED SOLUTION response.

Denoted by the paddle between the steps of FINDING 112B and ASSESSING 112C, the SME 108 can then approve the PROPOSED SOLUTION to move to the step of ASSESSING 112C where the PROPOSED SOLUTIONS are vetted and refined. This step can also be referred to as assessing, by way of the CORPORATE MEMBER, which of the PROPOSED SOLUTION to progress with a STATEMENT OF WORK in the COMMUNITY LED OPEN INNOVATION 100 system and method.

Denoted by the paddle positioned between the steps of ASSESSING 112C and ENGAGING 112D, the PROPOSED SOLUTION, which can also be referred to as an OPPORTUNITY, is communicated back to the AB 106 for review and approval to move to the step of ENGAGING. If the AB 106 group approves the movement of the PROPOSED SOLUTIONS to the step of ENGAGING 112D a STATEMENT OF WORK is created around the PROPOSED SOLUTION to be executed and fulfilled by the TECHNICAL COMMUNITY 118. This can also be referred to as engaging the TECHNICAL COMMUNITY to effectuate the STATEMENT OF WORK.

The SME 108 and the TECHNICAL COMMUNITY MEMBER 118 are then connected to communicate, anonymously if desired, and/or collaborate on the STATEMENT OF WORK together.

In an exemplary embodiment, the CORPORATE COMMUNITY can have many CORPORATE MEMBERS. This is illustrated in FIG. 6 as a series of lines numbered 104A, 104B, and 104C. Each CORPORATE MEMBER can be mutually exclusive form the other CORPORATE MEMBERS and their portfolio of OPPORTUNITIES can remain confidential, private, and anonymous. In addition, the TECHNICAL COMMUNITY 118 can have many TECHNICAL COMMUNITY GROUPS. This is illustrated in FIG. 6 as a series of lines numbered 116A, 116B, and 116C. Each TECHNICAL COMMUNITY GROUP can be mutually exclusive form the other TECHNICAL COMMUNITY members and their portfolio of OPPORTUNITIES can remain confidential, private, and anonymous.

Furthermore, an INVESTOR COMMUNITY 146 can utilize PORTFOLIO VISUALIZATION reports, charts, presentations, and tools to monitor, evaluate, and make decisions on where and how to buy, partner, fund, or otherwise invest in certain of the OPPORTUNITIES as they move through the COMMUNITY LED OPEN INNOVATION 100 system and method. In this regard, the INVESTOR COMMUNITY which is comprised of a plurality of individual investors, organizations, venture capital investors, private equity investors, institutional investors, and/or other investors can make determinations on which OPPORTUNITIES, TECHNICAL COMMUNITY MEMBERS, and/or CORPORATE MEMBERS to make investments in.

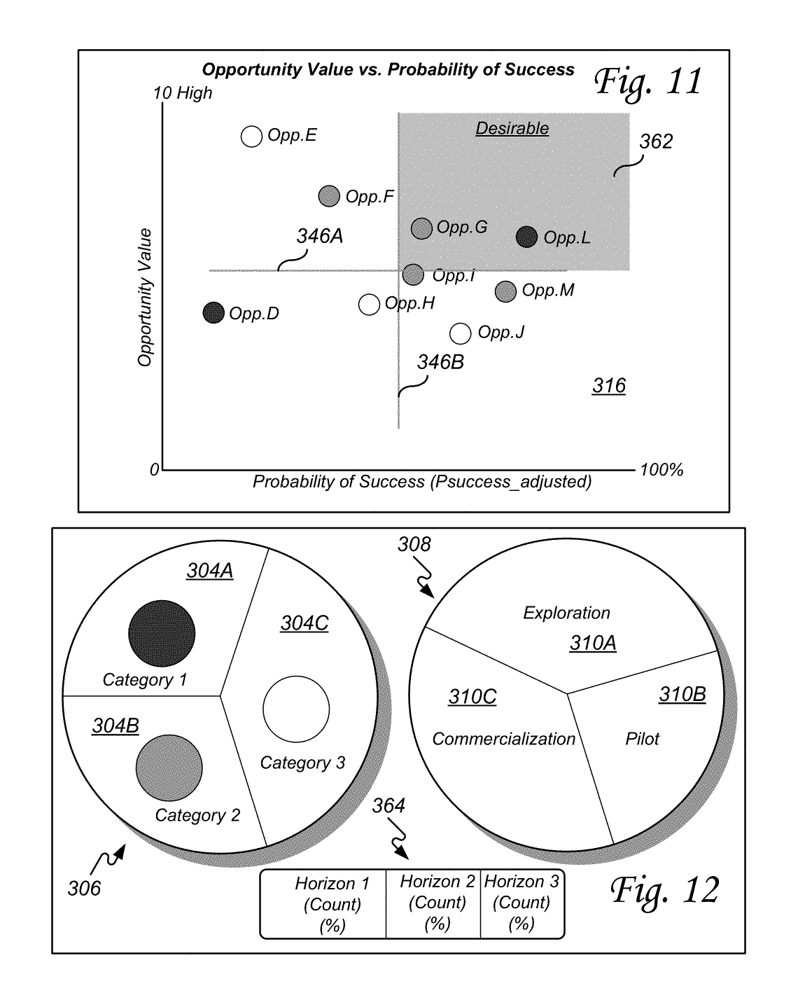

Referring to FIG. 7 there is illustrated one example of a method of progressing an OPPORTUNITY through the COMMUNITY LED OPEN INNOVATION 100 system and method. Building on at least FIGS. 2, 3, 4, and 6, FIG. 7 further details, in an exemplary embodiment, the flow of an OPPORTUNITY through the COMMUNITY LED OPEN INNOVATION 100 system and method.

Starting in the step of DEFINING 112A, in block 120 NEEDS can be harvested from a CORPORATE MEMBER, the CORPORATE COMMUNITY further comprising the CORPORATE MEMBER. In this regard, collecting, gathering, also referred to as harvesting NEEDS from a CORPORATE MEMBER provides a starting point in the COMMUNITY LED OPEN INNOVATION 100 system and method.

The NEEDS, also referred to OPPORTUNITIES, can then move to block 122, wherein NEEDS BRIEFS and TECHNICAL TARGET generation is where the harvested NEEDS can be refined and articulate into NEEDS BRIEFS and TECHNICAL TARGETS which are typically non-confidential and often anonymous as to CORPORATE MEMBER identity. Denoted by the SME 108 paddle positioned on steps 120 and 122, the SME 108 is instrumental in effectuating these steps.

The OPPORTUNITY then moves to block 124 where other steps perhaps unique to the CORPORATE MEMBER company, refinements, and other tasks can be completed prior to OPPORTUNITY review by the ACCOUNTABILITY BOARD (AB) 106.

Denoted by the AB 106 paddle positioned between steps DEFINING 112A and FINDING 112B, upon approval by the AB 106, under the step of FINDING 112B, the OPPORTUNITY moves to block 126 where the SME 108 can do an internal search at the CORPORATE MEMBER to see if a solution can be located prior to searching externally in the TECHNICAL COMMUNITY. In this regard, occasionally within large companies solutions can be found when a NEEDS BRIEF or TECHNICAL TARGET articulates the business need and is shared internally at the company. Searching internally first avoids the surprise later when an external solution is brought in only then to discover it is not needed. Denoted by the SME 108 paddle, the SME 108 can assist in effectuating block 126. After internal search, the OPPORTUNITY moves to block 128.

In block 128 an external search is initiated and the NEEDS BRIEF or TECHNICAL TARGET is broadcast to the TECHNICAL COMMUNITY. The OPPORTUNITY then moves to block 130 where other steps perhaps unique to the CORPORATE MEMBER company, refinements, and other tasks can be completed prior to PROPOSED SOLUTION review by the SME 108 in block 132.

Under the step of ASSESSING, in block 132 the SME 108 reviews the PROPOSED SOLUTIONS also referred to as the proposals. The SME 108 moves the approved PROPOSED SOLUTION to block 134 where the PROPOSED SOLUTION can be vetted further and refined prior to AB 106 review. The OPPORTUNITY then moves to block 136 where other steps perhaps unique to the CORPORATE MEMBER Company and other tasks can be completed prior to PROPOSED SOLUTION review by the AB 106 and IP evaluation in block 138.

Denoted by the AB 106 paddle positioned between the steps of ASSESSING 112C and ENGAGING 112D, if the AB 106 approves the PROPOSED SOLUTION the OPPORTUNITY moves to block 138 where, under the step of ENGAGING 112D, intellectual property (IP) evaluation and review, freedom to operate, IP capture and creation can take place with the SME 108 working with the COMMUNITY FACILITATOR (CF) 114 to securing IP right. In this regard, securing intellectual property rights associated with the PROPOSED SOLUTION prior to the step of engaging the TECHNICAL COMMUNITY to effectuate or fulfill a STATEMENT OF WORK can be an important step. The OPPORTUNITY then moves to block 140.

In block 140, the STATEMENT OF WORK can be initiated and the TECHNICAL COMMUNITY MEMBER associated with the PROPOSED SOLUTION can be engaged to perform the work and fulfill the contracted. The OPPORTUNITY then move to block 142 where other steps perhaps unique to the CORPORATE MEMBER company and other tasks can be completed prior to OPPORTUNITY returning to the COMMUNITY LED OPEN INNOVATION 100 system and method, as necessary, for further consideration and entry back into any of the steps 112A, 112B, 112C, or 112D depending on what the OPPORTUNITY requires.

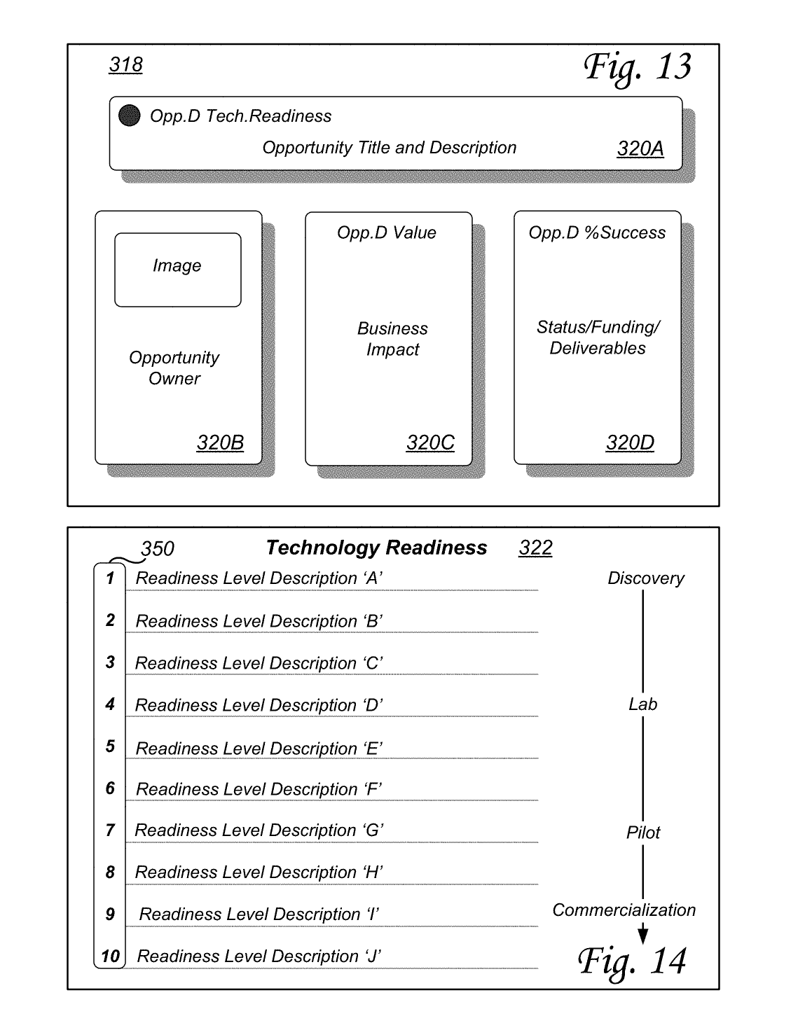

Referring to FIG. 8 there is illustrated one example of a PORTFOLIO VISUALIZATION software tool to visualize OPPORTUNITY PIPELINE ACTIVITY. Such PORTFOLIO VISUALIZATION can be online viewable documents, printed, and/or exported into a presentation format from the COMMUNITY LED OPEN INNOVATION 100 system and method data sources, as may be required and/or desired in a particular embodiment.

Use of the term “PIPELINE” or “PIPELINE ACTIVITY”, in the present invention, is intended to mean a graphical illustration or representation of various OPPORTUNITIES in various stages as they move through the COMMUNITY LED OPEN INNOVATION 100 system and method. In general, such use of the term PIPELINE or PIPELINE ACTIVITY is common in the innovation and research and development communities and that terminology, definition, and usage applies, in the present invention, as well.

Illustrated in FIG. 8 is a COMMUNITY LED OPEN INNOVATION OPPORTUNITY VISUALIZATION 300. In an exemplary embodiment, a pipeline line 302A and 302B represent graphically a PIPELINE where in the COMMUNITY LED OPEN INNOVATION 100 system and method each of the OPPORTUNITIES are currently located by reference to the steps of DEFINING 112A, FINDING 112B, ASSESSING 112C, and ENGAGING 112D, as illustrated. Additionally, those OPPORTUNITIES stopped or rejected, as example OPPORTUNITY ‘K’ (OPP.K) in block 112F, and those OPPORTUNITIES commercialized successfully, as example OPPORTUNITY ‘L’ (OPP.L) and OPPORTUNITY ‘M’ (OPP.M) in block 112E can also be illustrated.

In this exemplary embodiment, OPPORTUNITIES ‘A’, ‘B’, and ‘C’ are illustrated as being in the step of DEFINING 112A. In addition, OPPORTUNITIES ‘D’ and ‘E’ are illustrated as being in the step of FINDING 112B and OPPORTUNITIES ‘F’, ‘G’, and ‘H’ are illustrated as being in the step of ASSESSING 112C. Furthermore, OPPORTUNITIES ‘I’ and ‘J’ are illustrated as being in the step of ENGAGING 112D. For disclosure purposes the nomenclature of OPPORTUNITY ‘A’, ‘B’ and so on can be abbreviated as OPP.A, OPP.B and so on, and is utilized throughout this specification and in particular in at least FIGS. 8, 9, 10, 11, and 13.

Also illustrated in the PIPELINE ACTIVITY visualization are the SUBJECT MATTER EXPERT (SME) 108 and ACCOUNTABILITY BOARD (AB) 106 paddles denoting review and decision points in the COMMUNITY LED OPEN INNOVATION 100 system and method. In addition, a color coded legend 304 can indicated how each of the OPPORTUNITIES has been assigned a category of OPPORTUNITY TYPES. Such OPPORTUNITY TYPES can be selected differently by each of the CORPORATE MEMBERS to indicate how they categorize the OPPORTUNITIES. In this regard, for example and not a limitation, OPPORTUNITY TYPES can include, as ‘CATEGORY 1’ one color OPPORTUNITIES that ‘Grow the Top Line Revenue of the Company’, ‘CATEGORY 2’ second color can indicate which OPPORTUNITIES represent ‘Cost Saving to the Bottom Line Revenue of the Company’, and ‘CATEGORY 3’ third color can indicate which of the OPPORTUNITIES represent a Sustainability, Good for the Planet′ type project. These are just examples and other definitions can be assigned by each CORPORATE MEMBER to the CATEGORY 1, 2, and 3, and any number of CATEGORIES can be included, as may be required and/or desired in a particular embodiment.

Referring to FIG. 9 there is illustrated one example of a PORTFOLIO VISUALIZATION software tool to visualize OPPORTUNITY PIPELINE ACTIVITY. Such PORTFOLIO VISUALIZATION can be online viewable documents, printed, and/or exported into presentations from the COMMUNITY LED OPEN INNOVATION data sources, as may be required and/or desired in a particular embodiment. Illustrated in FIG. 9 is a TECHNOLOGY READINESS VISUALIZATION 312.

In an exemplary embodiment, for example and not a limitation, each of the OPPORTUNITIES can be shown between PIPELINE lines 302A and 302B organized by the TECHNICAL READINESS of each OPPORTUNITY. In this regard, the TECHNICAL READINESS is a ranking of how close an OPPORTUNITY is to COMMERCIAL READINESS on a scale, for example and not a limitation, from one to ten, wherein a TECHNICAL READINESS ranking of a one or two could corresponds to different levels of early stage or discovery stage readiness. A TECHNOLOGY READINESS ranking of a three or four could correspond to different levels of lab scale readiness. A TECHNOLOGY READINESS ranking of a five, six, or seven could correspond to different levels of pilot scale readiness, and a TECHNOLOGY READINESS ranking of eight, nine, or ten could correspond to different levels of commercial readiness. In general, the TECHNOLOGY READINESS ranking is part of a COMMON TECHNOLOGY LANGUAGE to impart as a way of being able to assign, contrast, and compare by a ranking each of a plurality of different OPPORTUNITIES and is useful to visualize a group of OPPORTUNITIES within a portfolio.

Referring to FIG. 10 there is illustrated one example of a PORTFOLIO VISUALIZATION software tool to visualize OPPORTUNITY PIPELINE ACTIVITY. Such PORTFOLIO VISUALIZATION can be online viewable documents, printed, and/or exported into a presentation from the COMMUNITY LED OPEN INNOVATION 100 system and method data sources, as may be required and/or desired in a particular embodiment. Illustrated in FIG. 10 is a COMMERCIAL READINESS versus TECHNOLOGY READINESS VISUALIZATION 314 chart.

In an exemplary embodiment, COMMERCIAL READINESS refers to an OPPORTUNITY'S readiness to be commercialized. Differing from TECHNICAL READINESS in that TECHNICAL READINESS is focused on the technology reaching a readiness state to be commercialized, and COMMERCIAL READINESS is focused on the organization's or CORPORATE MEMBER'S readiness to move the technology from research and development to a commercial market execution. In this regard, in an exemplary embodiment, COMMERCIAL READINESS can be determined through a COMMERCIAL READINESS questionnaire such as better illustrated in at least FIG. 18. Such a questionnaire can prompt a series of questions related to commercialization risk like “Is there a commitment to commercialize?”, “Has a successful pilot be completed?”, “Has the concept been tested with consumers?”, “Has a commercialization plan been developed?”, and other types and kinds of questions, each of which can be a MATHEMATICALLY WEIGHTED QUESTION such that as the questions are answered in the affirmative the COMMERCIAL READINESS percentage increases.

With reference to FIG. 10, plotting the COMMERCIAL READINESS versus the TECHNICAL READINESS gives a visual representation of how, as an OPPORTUNITY moves towards TECHNICAL READINESS on the X-axis, the CORPORATE MEMBER is preparing internally for commercialization, which is measured as COMMERCIAL READINESS on the Y-axis. To visualize OPPORTUNITIES that are lagging behind on COMMERCIAL READINESS, a warning ‘NOT READY’ zone 348 is overlaid on the chart. OPPORTUNITIES, such as, in this example, OPPORTUNITY ‘J’ and ‘M’ abbreviated as OPP.J and OPP.M can clearly be seen as lagging and should be an early warning sign to the CORPORATE MEMBER to deep-dive on these OPPORTUNITIES to understand why the organization is failing to adequately prepare for commercialization.

Referring to FIG. 11 there is illustrated one example of a PORTFOLIO VISUALIZATION software tool to visualize OPPORTUNITY PIPELINE ACTIVITY. Such PORTFOLIO VISUALIZATION can be online viewable documents, printed, and/or exported into a presentation from the COMMUNITY LED OPEN INNOVATION 100 system and method data sources, as may be required and/or desired in a particular embodiment. Illustrated in FIG. 11 is an OPPORTUNITY VALUE versus PROBABILITY OF SUCCESS 316 chart.

OPPORTUNITY VALUE is the ranking of business value, also referred to as BUSINESS IMPACT assigned to each of a plurality of OPPORTUNITIES on a scale from low, little BUSINESS IMPACT, to high, lots of BUSINESS IMPACT. Such ranking can be numerically represented, for example and not a limitation, from one to ten.

The ranking can be assigned more subjectively for early state OPPORTUNITIES then can be updated over time as the OPPORTUNITY progresses towards commercialization and the business case becomes more validated. In this regard, each OPPORTUNITY can be ranked on the same criteria regardless of development stage which then enables a portfolio view of the different OPPORTUNITIES and an indication of each of OPPORTUNITIES relative positive BUSINESS IMPACT.

Additionally, values ranking can be assigned based on different criteria as better illustrated in at least FIG. 15 as ‘CRITERIA 1’, ‘CRITERIA 2’, ‘CRITERIA 3’, and ‘CRITERIA 4’. For example and not a limitation CRITERIA 1 could be ‘New Revenue Generation’ and a dollar range for each value ranking level can be established from a one ranking, low dollar range ranking to a ten ranking, high dollar range ranking. CRITERIA 2 could be ‘Increased Volume of Product Sold’ range for each value ranking level there can be established from a one ranking for a low product volume increase to a ten ranking, for a high product volume increases. CRITERIA 3 could be ‘Productivity Cost Savings’ where for each value ranking level there can be established a one ranking, for small cost savings to a ten ranking for a lot of cost savings. CRITERIA 4 could be ‘Sustainability Goals’ where for each ranking level there can be established a one ranking, for small impact on sustainability goals to a ten ranking, for a big impact on sustainability. In this regard, each OPPORTUNITY can be ranked on based on best CRITERIA and represents the positive BUSINESS IMPACT the OPPORTUNITY can have on the business.

PROBABILITY OF SUCCESS is the probability that an OPPORTUNITY will reach a TECHNICAL READINESS ranking of at least ready for commercialization. This indicates that a technical success has been achieved and that the technology, if desired, can be commercialized.

In an exemplary embodiment, the PROBABILITY OF SUCCESS for each of an opportunity can be determined through a PROBABILITY OF SUCCESS questionnaire such as better illustrated in at least FIG. 17 and corresponding disclosure.

In another exemplary embodiment, the PROBABILITY OF SUCCESS can be determined through an analytical method and/or by way of a hybrid analytical method and questionnaire method, as may be required and/or desired in a particular embodiment.

Since there are almost always extraneous circumstances, broadly categorized as technical complexities, operational complexities, and investment complexities such as capital, facility, capacity risks that can influence the PROBABILITY OF SUCCESS, from a macro event perspective, a more accurate reflection of the true PROBABILITY OF SUCCESS can better be determined by multiplying the value by the OPPORTUNITY COMPLEXITY CONFIDENCE LEVEL determined, in a preferred embodiment, by way of a lookup table as better illustrated in at least FIG. 16 and corresponding disclosure.

In an exemplary embodiment, a chart of OPPORTUNITY VALUE of each OPPORTUNITY along the y-axis versus the adjusted PROBABILITY OF SUCCESS (Psuccess_adjusted) on the X-axis can be generated. In this regard, a four quadrant plot can be envisioned with the addition of lines 346A and 346B. Once constructed the upper right quadrant 362 is the most ‘Desirable’ region for OPPORTUNITIES to achieve, as these OPPORTUNITIES are the highest OPPORTUNITY VALUE and have the highest PROBABILITY OF SUCCESS. This chart also identifies visually the OPPORTUNITIES that fall outside the ‘Desirable’ quadrant 362, which can facilitate a deeper dive to understand the particular status the these OPPORTUNITIES.

Referring to FIG. 12 there is illustrated one example of a PORTFOLIO VISUALIZATION software tool to visualize OPPORTUNITY PIPELINE ACTIVITY. Such PORTFOLIO VISUALIZATION can be online viewable documents, printed, and/or exported into a presentation from the COMMUNITY LED OPEN INNOVATION 100 system and method data sources, as may be required and/or desired in a particular embodiment. Illustrated in FIG. 12 are an OPPORTUNITY CATEGORY summary chart 306, STATEMENT OF WORK summary chart 308, and a HORIZONS summary chart 364.

In an exemplary embodiment, visualization can be generated to illustrate the distribution of OPPORTUNITIES based on the CATEGORY assigned to each OPPORTUNITY in an OPPORTUNITY CATEGORY summary chart 306. As example and not a limitation, a color coded legend 304A, 304B, and 304C can indicate how each of the OPPORTUNITIES has been assigned a category of OPPORTUNITY TYPES. Such OPPORTUNITY TYPES can be selected by each of the CORPORATE MEMBERS to indicate how they categorize the OPPORTUNITIES. In this regard, for example and not a limitation, OPPORTUNITY TYPES can include, as ‘CATEGORY 1’ one color OPPORTUNITIES that ‘Grow the Top Line Revenue of the Company’, ‘CATEGORY 2’ second color can indicate which OPPORTUNITIES represent ‘Cost Saving to the Bottom Line Revenue of the Company’, and ‘CATEGORY 3’ third color can indicate which of the OPPORTUNITIES represent a ‘Sustainability, Good for the Planet’ type project. These are just examples and other definitions can be assigned to the CATEGORY 1, 2, and 3, and any number of CATEGORIES can be included, as may be required and/or desired in a particular embodiment. An OPPORTUNITY category summary 306, can be constructed by arranging the quantity of each, percentage of each, or other measurement of each type, as illustrated in the Figure, in a pie, bar, line, or other type of comparison chart or table can provide a visualization of the distribution of each type of CATEGORY.

As may be required and/or desired in a particular embodiment, a CORPORATE MEMBER may decide and/or set business goals as to what percentage or count they desire of each of CATEGORY 1, 2, and 3 type OPPORTUNITY projects as a way to maintain a balanced portfolio. In this regard, the OPPORTUNITY CATEGORY summary chart 306 can assist in tracking progress and balance against business goals.

In another exemplary embodiment, visualization can be generated to illustrate the distribution of OPPORTUNITIES based on the STATEMENT OF WORK type in a STATEMENT OF WORK summary chart 308. As example and not a limitation, STATEMENT OF WORKS can be utilized to start three kinds of projects EXPLORATION PROJECTS 310A, PILOT PROJECTS 310B, and COMMERCIALIZATION PROJECTS 310C. In other exemplary embodiment, other types and kinds of projects can be initiated, as may be required and/or desired in a particular embodiment. Arranging the quantity of each or percentage of each or other measurement of each type, as illustrated in the Figure, in a pie, bar, line, or other type of comparison chart or table can provide a visualization of the distribution of each type of STATEMENT OF WORK.

As may be required and/or desired in a particular embodiment, a CORPORATE MEMBER may decide and/or set business goals as to what percentage or count they desire of each type of STATEMENT OF WORK project as a way to maintain a balanced portfolio. In this regard, the STATEMENT OF WORK summary chart 308 can assist in tracking progress and balance against business goals.

In another exemplary embodiment, visualization can be generated to illustrate the distribution of OPPORTUNITIES based on the HORIZON types in a HORIZONS summary chart 364.

Use of the term “HORIZON”, in the present invention, is intended to mean a classification of a group of OPPORTUNITIES. In general, ‘HORIZON 1’ is a group classification of OPPORTUNITIES that are incremental improvements, line extensions, or otherwise smaller innovations on typically existing products or product lines. ‘HORIZON 2’ is a group classification of OPPORTUNITIES that are innovations that maybe new to the CORPORATE MEMBER but not necessarily new to the world. ‘HORIZON 3’ is a group classification of OPPORTUNITIES that are innovations that may be new to the world and considered breakthrough or transformational.

In this regard, classifying OPPORTUNITIES as HORIZON 1, 2, and 3 provides a perspective as to how many OPPORTUNITIES in each category are being worked on and thus how the portfolio is balanced between incremental, new to company, and new to world type OPPORTUNITIES. Arranging the quantity of each, percentage of each, or other measurement of each type, as illustrated in the Figure, in a pie, bar, line, or other type of comparison chart or table can provide a visualization of the distribution of each type of HORIZON.

As may be required and/or desired in a particular embodiment, a CORPORATE MEMBER may decide and/or set business goals as to what percentage they desire of each type of HORIZON as a way to maintain a balanced portfolio. In this regard, the HORIZON summary chart 364 can assist in tracking progress and balance against business goals.

Referring to FIG. 13 there is illustrated one example of a PORTFOLIO VISUALIZATION software tool to visualize OPPORTUNITY PIPELINE ACTIVITY. Such PORTFOLIO VISUALIZATION can be online viewable documents, printed, and/or exported into a presentation from the COMMUNITY LED OPEN INNOVATION 100 system and method data sources, as may be required and/or desired in a particular embodiment. Illustrated in FIG. 13 is an OPPORTUNITY SUMMARY BRIEF 318.

In an exemplary embodiment each OPPORTUNITY can be summarized in a viewable OPPORTUNITY SUMMARY BRIEF 318. Such a brief can also be referred to as a report and can include an indication of the OPPORTUNITY TECHNICAL READINESS and CATEGORY type color indication, as well as, the OPPORTUNITY title and description in a report header 320A. In addition, the OPPORTUNITY SUMMARY BRIEF 318 can include a representative image illustrative of, or related to, the OPPORTUNITY along with the OPPORTUNITY CORPORATE MEMBER owner, also referred to as the OPPORTUNITY OWNER, such as the SME in a section 320B. The report can also include an indication of OPPORTUNITY VALUE and BUSINESS IMPACT section 320C and the OPPORTUNITY PROBABILITY OF SUCCESS RATE along with OPPORTUNITY status, funding, and deliverables section 320D. In other embodiments, more or less sections can be included and the content of the sections can be altered, and/or changed, as may be required and/or desired in a particular embodiment.

Such OPPORTUNITY SUMMARY BRIEF 318 can be a useful one-page summary of each OPPORTUNITY and select one-pagers can be useful in deep-dive meetings as certain of the OPPORTUNITIES are discussed in greater detail.

Referring to FIG. 14 there is illustrated one example of a TECHNOLOGY READINESS table 322. In an exemplary embodiment, a TECHNOLOGY READINESS table 322 can assign a TECHNOLOGY READINESS level description to each of a numeric rating scale 350. Organized from discovery, lab, pilot, to commercialization such TECHNOLOGY READINESS level descriptions ‘A’ through ‘J’ can be applied to a scale, for example, from one to ten. Other numbers of scale, levels, and TECHNOLOGY READINESS level descriptions can be utilized, as may be required and/or desired in a particular embodiment.

As example, in an exemplary embodiment, the following can be used as a technology readiness table 322.

### Technology Readiness

Ranking 1: Basic Research: basic principles are observed and reported
Ranking 2: Applied Research: technology concept and/or application formulated
Ranking 3: Critical function, proof of concept established
Ranking 4: Laboratory testing of prototype component or process
Ranking 5: Laboratory testing of integrated system
Ranking 6: Prototype system in fabrication
Ranking 7: Prototype system verified
Ranking 8: Integrated pilot system demonstrated
Ranking 9: System incorporated in commercial design
Ranking 10: System ready for full scale deployment

Generally, the TECHNOLOGY READINESS levels range from low for discovery stage, higher for research/lab stage, higher yet for proto-type/pilot, and highest for late stage development and route to ready for commercialization.

Referring to FIG. 15 there is illustrated one example of an OPPORTUNITY VALUE table 324. In an exemplary embodiment, a ranking 352 of business value also referred to as or BUSINESS IMPACT assigned to each of a plurality of OPPORTUNITIES on a scale from low to high. Such ranking can be numerically represented, for example and not a limitation, from one to ten.

The ranking 352 can be assigned more subjectively for early state OPPORTUNITIES then can be updated over time as the OPPORTUNITY progresses towards commercialization and the business cases becomes more validated. In this regard, each OPPORTUNITY can be ranked on the same criteria regardless of development stage which then enables a portfolio view of the different OPPORTUNITIES and an indication of each of OPPORTUNITIES relative BUSINESS IMPACT.

Additionally, values ranking 352 can be assigned based on different criteria as better illustrated in at least FIG. 15 as ‘CRITERIA 1’, ‘CRITERIA 2’, ‘CRITERIA 3’, and ‘CRITERIA 4’. For example and not a limitation CRITERIA 1 could be ‘New Revenue Generation’ and a dollar range for each value ranking level there can be established from low dollar range ranking of a one to high dollar range ranking of a ten. CRITERIA 2 could be ‘Increased Volume of Product Sold’ range for each value ranking level. There can be established from low product volume increases ranking of a one to high product volume increases ranking of a ten. CRITERIA 3 could be ‘Productivity Cost Savings’ where for each value ranking level there can be established for a small cost savings ranking of a one to for a lot of cost savings ranking of a ten. CRITERIA 4 could be ‘Sustainability Goals’ where for each ranking level there can be established for a small impact on sustainability goals ranking of a one to for a big impact on sustainability goals a ranking of a ten. In this regard, each OPPORTUNITY can be ranked based on the best CRITERIA and represents the BUSINESS IMPACT the OPPORTUNITY can have on the business.

Under each of the CRITERIA a description can be associated with a ranking level. In this regard, a table can be formed which then allows each OPPORTUNITY to be classified as to a value ranking. As the OPPORTUNITY progresses through the COMMUNITY LED OPEN INNOVATION 100 system and method the OPPORTUNITY VALUE ranking for the OPPORTUNITY can be updated as more of a business case is developed.

As an example, below are some OPPORTUNITY VALUE rankings associated with a CRITERIA 1 of ‘Cost Savings’ and a CRITERIA 2 of ‘Intangible Benefit’.

### Ranking 1

Cost savings: Less than $1,000,000 over five years.
Intangible benefit: Competitive advantage for less than one year
. . .

### Ranking 5

Cost savings: Less than $10,000,000 over five years.
Intangible benefit: Differentiates existing product or positive impact on environment or Competitive Advantage less than three years.
. . .

### Ranking 10

Cost savings: Greater than $10,000,000 over five years.
Intangible benefit: Enables a new platform or competitive advantage greater than three years.

In this example a higher OPPORTUNITY VALUE ranking is associated with a greater BUSINESS IMPACT. In a plurality of exemplary embodiments, the CRITERIA and descriptions can be matched best to the type of business and other circumstances, for each CORPORATE MEMBER, as may be required and/or desire in a particular embodiment.

Referring to FIG. 16 there is illustrated one example of a COMPLEXITY CONFIDENCE LEVEL table 326. In an exemplary embodiment, probability confidence levels 354 can be assigned to a matrix of ‘Technical’, ‘Operational’, ‘Investment’, and other types and kinds of categories that impact or contribute to the complexity of the OPPORTUNITY. In this regard, in addition to the technical risk to reach COMMERCIAL READINESS which is characterized as the PROBABILITY OF SUCCESS, the complexity of the OPPORTUNITY can impact the PROBABILITY OF SUCCESS as well. To account for these complexities a table 326 can associate complexity descriptions by complexity categories, such as ‘Technical’, ‘Operational’, and ‘Investment’ with complexity confidence levels 354. In this regard, the probability confidence levels 354 can be utilized to adjust the PROBABILITY OF SUCCESS to reflect that it is not just a technical success that is sought but a technical success in the context that the OPPORTUNITY can really be made and achieve commercial readiness.

As an example, below are some complexity confidence levels associated with ‘Technical’, ‘Operational’, and ‘Investment’ descriptions:

### Confidence Level 45%

Technical: Never been done before, requires Discovery.
Operational: Greater than 5 year payback; ongoing increased people expense.
Investment: Requires significant capital investment.
. . .

### Confidence Level 70%

Technical: Some technical and operations hurdles. Outside expertise exists.
Operational: 3 year payback; no impact on number of people required.
Investment: Requires moderate capital investment.
. . .

### Confidence Level 90%

Technical: No technical and operations hurdles.
Operational: Less than 1 year payback; no impact on number of people required.
Investment: Little to no capital investment.

In this example a higher confidence level is associated with a lower or easier OPPORTUNITY execution. In a plurality of exemplary embodiments, the complexity categories and descriptions can be matched best to the type of business and other circumstances, for each CORPORATE MEMBER, as may be required and/or desire in a particular embodiment.

Referring to FIG. 17 there is illustrated one example of a PROBABILITY OF SUCCESS QUESTIONNAIRE 328 comprising MATHEMATICALLY WEIGHTED QUESTIONS. In an exemplary embodiment, the PROBABILITY OF SUCCESS for each of an OPPORTUNITY can be determined through a questionnaire comprising MATHEMATICALLY WEIGHTED QUESTIONS.

In an exemplary embodiment, such a questionnaire can prompt a series of MATHEMATICALLY WEIGHTED QUESTIONS W0%-W9% shown in area 356 associated with PROBABILITY OF SUCCESS questions wherein the questions are related to technical risks like, for example, Question ‘A’ “Has the technology been demonstrated at lab scale?”, Question ‘B’ “Has a customer agreed to a pilot test?”, Question ‘C’ “Is all funding, resources, and agreements in place for a pilot test?”, Question ‘D’ “Has legal provide a freedom to operate clearance?”, Question ‘E’ “Has regulatory approved the solution?”, and other types and kinds or questions. Each question can be mathematically weighted, as example, W0%=10%, W1%=5%, W3%=15%, W4%=10%, W5%=5% such that as the questions are answered in the affirmative the PROBABILITY OF SUCCESS increases, in that the summation of the weighted affirmatively answered questions add towards 100%. Each OPPORTUNITY for a CORPORATE MEMBER can be assessed with the same set of questions and the questionnaire answers updated frequently as the OPPORTUNITY progresses.

Since there are almost always extraneous circumstances, broadly categorized as ‘Technical’ complexities, ‘Operational’ complexities, and ‘Investment’ complexities such as capital, facilities, capacity, and other complexity risks that can influence the PROBABILITY OF SUCCESS from a macro event perspective a more accurate reflection of the true PROBABILITY OF SUCCESS can better be determined by multiplying the value by the OPPORTUNITY COMPLEXITY CONFIDENCE LEVEL determined, in a preferred embodiment, by way of a lookup table though other methods can be employed. In this regard, the PROBABILITY OF SUCCESS (Psuccess_adjusted) becomes the adjusted product of the weighted determined PROBABILITY OF SUCCESS (Psuccess_questionaire) multiplied by the OPPORTUNITY COMPLEXITY CONFIDENCE LEVEL (Confidence Level).

Psuccess_{adjust}=ConfidenceLevel·Psuccess_{questionaire}

Referring to FIG. 18 there is illustrated one example of a COMMERCIAL READINESS QUESTIONNAIRE 330 comprising MATHEMATICALLY WEIGHTED QUESTIONS. Differing from TECHNICAL READINESS in that TECHNICAL READINESS is focused on the technology reaching a readiness state to be commercialized, and COMMERCIAL READINESS is focused on the organization or CORPORATE MEMBER'S readiness to move the technology from research and development to a commercial market execution. In this regard, in an exemplary embodiment COMMERCIAL READINESS can be determined through a questionnaire comprising MATHEMATICALLY WEIGHTED QUESTIONS.

In an exemplary embodiment such a questionnaire can prompt a series of MATHEMATICALLY WEIGHTED QUESTIONS W0%-W9% shown in area 358 with associated COMMERCIAL READINESS questions wherein the questions are related to commercialization risks like, for example, Question ‘A’ could be “Is there a commitment to commercialize?”, Question ‘B’ “Has a successful pilot be completed?”, Question ‘C’ “Has the concept been tested with consumers?”, Question ‘D’ “Has a commercialization plan been developed?”, and other types and kinds of questions. Each question can be mathematically weighted, as example, W0%=5%, W1%=10%, W3%=7% such that as the questions are answered in the affirmative the COMMERCIAL READINESS probability increases, in that the summation of the weighted affirmatively question add towards 100%. Each OPPORTUNITY for a CORPORATE MEMBER can be assessed with the same set of questions and the questionnaire answers updated frequently as the OPPORTUNITY progresses.

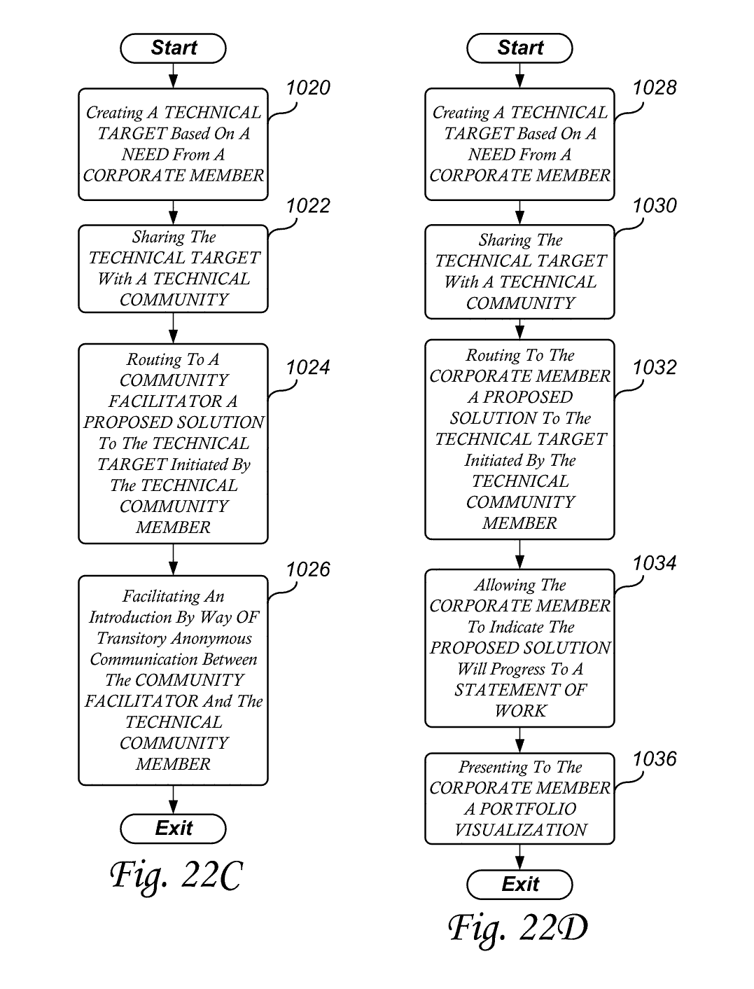

Referring to FIG. 19 there is illustrated one example of a CORPORATE COMMUNITY RATINGS 332. In an exemplary embodiment, CORPORATE MEMBER scores and CORPORATE MEMBER rankings can be accrued as activity in the COMMUNITY LED OPEN INNOVATION 100 system and method progresses. In this regard, CORPORATE MEMBERS can see how they score in a plurality of different measurements. In addition, each CORPORATE MEMBER can see how they rank, within the CORPORATE COMMUNITY, in a plurality of different measurements. This information can help the CORPORATE MEMBER better understand how successful their external innovation program is through scores against different individual performing measurements, as well as, through rankings against peer CORPORATE MEMBERS.

As example, a viewable report list having SCORES SC0-SC4 and RANKINGS RK0-RK4 area 362 can correspond to a series of CORPORATE MEMBER SCORE FOR THIS MEASURE ‘A’-‘E’ and CORPORATE MEMBER RANKING IN THIS MEASUREMENT IN THE CORPORATE COMMUNITY ‘A’-‘E’, as illustrated in FIG. 19. Any number of SCORES, RANKINGS, and measurement criteria can be utilized, as may be required and/or desired in a particular embodiment.

SCORE 0 (SC0) for measurement ‘A’ could be the ‘Number of NEEDS BRIEFS Initiated to Date’. SCORE 1 (SC1) for measurement ‘B’ could be the ‘Number of STATEMENT OF WORKS Initiated to Date’ and so one with other SCORES and measurements.

RANKING 0 (RK0) measurement in the CORPORATE COMMUNITY ‘A’ could be an indication of where the CORPORATE MEMBER ranks within the whole CORPORATE COMMUNITY with respect to the ‘Number of NEEDS BRIEFS Initiated to Date’. RANKING 1 (RK1) measurement in the CORPORATE COMMUNITY ‘B’ could be an indication of where the CORPORATE MEMBER ranks within the whole CORPORATE COMMUNITY with respect to the ‘Number of STATEMENT OF WORKS Initiated to Date’. Such SCORES and RANKINGS can be used to help CORPORATE MEMBERS understand where they can fine-tune their internal efforts to drive better innovation results and can reassure others that they are performing in a top percentile amongst peer CORPORATE MEMBERS.

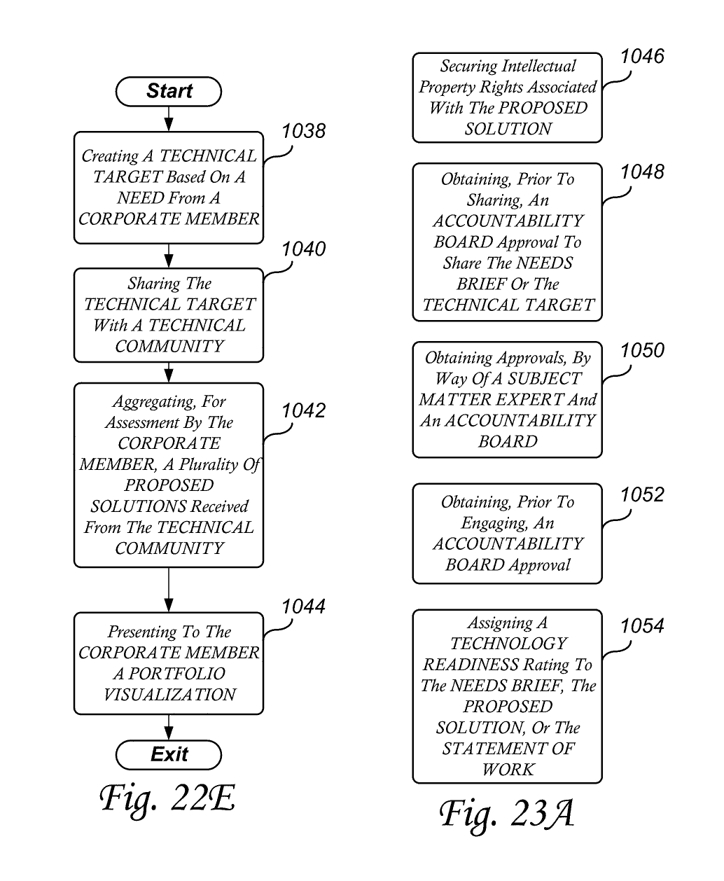

Referring to FIG. 20 there is illustrated one example of a TECHNICAL COMMUNITY RATINGS 334. In an exemplary embodiment, TECHNICAL COMMUNITY MEMBER scores and TECHNICAL COMMUNITY MEMBER rankings can be accrued as activity in the COMMUNITY LED OPEN INNOVATION 100 system and method progresses. In this regard, TECHNICAL COMMUNITY MEMBERS can see how they score in a plurality of different measurements. In addition, each TECHNICAL COMMUNITY MEMBER can see how they rank, within the TECHNICAL COMMUNITY, in a plurality of different measurements. This information can help to the TECHNICAL COMMUNITY MEMBER to better understand how successful they are at working with CORPORATE MEMBERS, as well as, inform CORPORATE MEMBERS and INVESTOR MEMBERS who are the top TECHNICAL COMMUNITY MEMBERS, and track how they score in different measurements individually, as well as, provide insights into how they rank against other TECHNICAL COMMUNITY MEMBERS.

As example, a viewable report list having a SCORES ES0-ES4 and RANKING RA0-RA4 area 364 can correspond to a series of TECHNICAL COMMUNITY MEMBER SCORE FOR THIS MEASURE ‘A’-‘E’ and TECHNICAL COMMUNITY MEMBER RANKING IN THIS MEASUREMENT IN THE TECHNICAL COMMUNITY ‘A’-‘E’ as illustrated in FIG. 20. Any number of SCORES, RANKINGS, and measurement criteria can be utilized, as may be required and/or desired in a particular embodiment.

SCORE 0 (ES0) for measurement ‘A’ could be the ‘Number of NEEDS BRIEFS the TECHNICAL COMMUNITY MEMBER has Responded to Over a Time Period’. SCORE 1 (ES1) for measurement ‘B’ could be the ‘Number of STATEMENT OF WORKS the TECHNICAL COMMUNITY MEMBER has Worked On Over a Period of Time’ and so one with the other SCORES and measurements.

RANKING 0 (RA0) measurement in the TECHNICAL COMMUNITY ‘A’ could be an indication of where the TECHNICAL COMMUNITY MEMBER ranks, within the whole TECHNICAL COMMUNITY, with respect to the ‘Number of NEEDS BRIEFS Responded to Over a Time Period’. RANKING 1 (RA1) measurement in the TECHNICAL COMMUNITY ‘B’ could be an indication of where the TECHNICAL COMMUNITY MEMBER ranks, within the whole TECHNICAL COMMUNITY, with respect to the ‘Number of STATEMENT OF WORKS Worked on Over a Time Period’. Such SCORES and RANKING can be used to help TECHNICAL COMMUNITY MEMBERS understand where they can fine-tune their skills to drive better innovation results and can inform CORPORATE MEMBERS and INVESTORS MEMBERS of the caliber of a TECHNICAL COMMUNITY MEMBER they are working with or considering working with.

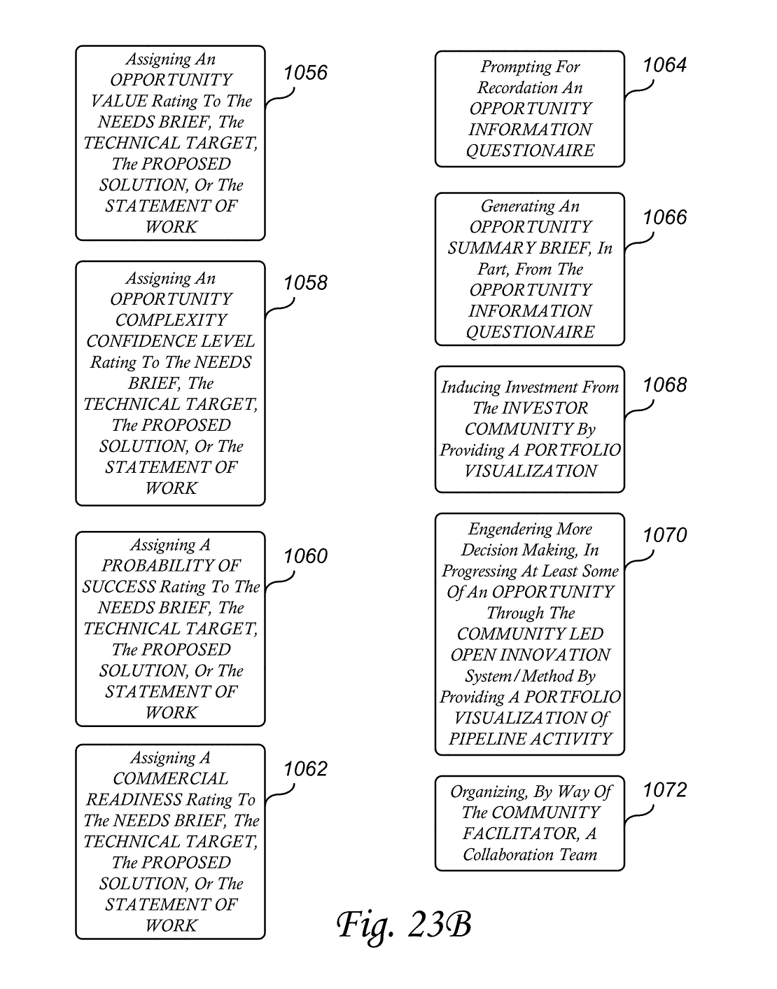

Referring to FIG. 21 there is illustrated one example of an INVESTOR COMMUNITY RATINGS 336. In an exemplary embodiment, INVESTOR COMMUNITY MEMBER scores and INVESTOR COMMUNITY MEMBER rankings can be accrued as activity in the COMMUNITY LED OPEN INNOVATION 100 system and method progresses. In this regard, INVESTOR COMMUNITY MEMBERS can see how they score in a plurality of different measurements. In addition, each INVESTOR COMMUNITY MEMBER can see how they rank, within the INVESTOR COMMUNITY, in a plurality of different measurements. This information can help to the INVESTOR COMMUNITY MEMBER to better understand how successful they are at working with CORPORATE MEMBERS and TECHNICAL COMMUNITY MEMBERS, as well as, inform other INVESTOR MEMBERS, CORPORATE MEMBERS, and TECHNICAL COMMUNITY MEMBERS of who are the top INVESTOR COMMUNITY MEMBERS, how they score in different measurements individually, as well as, provide insights into how they rank against other INVESTOR COMMUNITY MEMBERS.

As example, a viewable report list having a SCORES DL0-DL4 and RANKING IR0-IR4 area 366 can correspond to a series of INVESTOR COMMUNITY MEMBER SCORE FOR THIS MEASURE ‘A’-‘E’ and INVESTOR COMMUNITY MEMBER RANKING IN THIS MEASUREMENT IN THE INVESTOR COMMUNITY ‘A’-‘E’ as illustrated in FIG. 21. Any number of SCORES, RANKINGS, and measurement criteria can be utilized, as may be required and/or desired in a particular embodiment.

SCORE 0 (DL0) for measurement ‘A’ could be the ‘Number of Investments Made in the TECHNICAL COMMUNITY Over a Time Period’. SCORE 1 (DL1) for measurement ‘B’ could be the ‘Number of Investment in Commercial Products over a Period of Time’, and so one with the other SCORES and measurements.

RANKING 0 (IR0) measurement in the INVESTOR COMMUNITY ‘A’ could be an indication of where the INVESTOR COMMUNITY MEMBER ranks within the whole INVESTOR COMMUNITY with respect to the ‘Number of Investments Made in the TECHNICAL COMMUNITY over a Time Period’. RANKING 1 (IR1) measurement in the INVESTOR COMMUNITY ‘B’ could be an indication of where the INVESTOR COMMUNITY MEMBER ranks, within the whole INVESTOR COMMUNITY, with respect to the ‘Number of Investments in Commercial Products over a Time Period’. Such SCORES and RANKINGS can be used to help INVESTOR COMMUNITY MEMBERS understand where they can fine-tune their investment strategies to drive better return on investment results and can inform CORPORATE MEMBERS, TECHNICAL COMMUNITY MEMBERS, and other INVESTORS MEMBERS of the most active and most successful INVESTOR COMMUNITY MEMBERS.

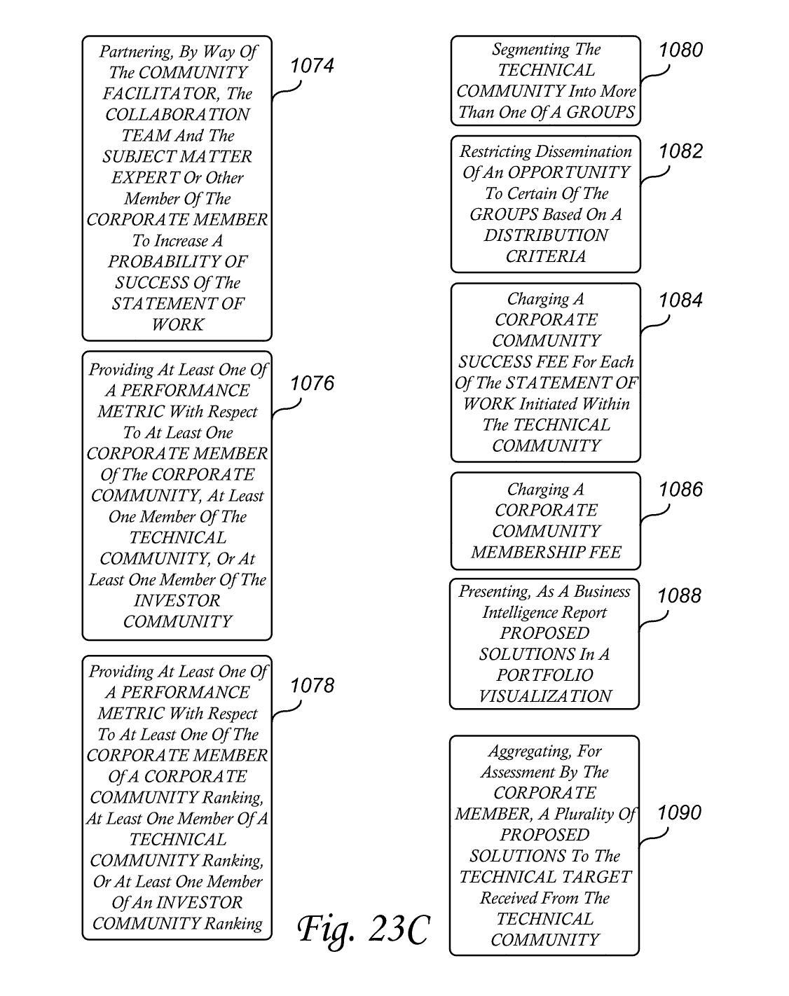

Referring to FIG. 22A-22E there is illustrated examples of COMMUNITY LED OPEN INNOVATION 100 system and method operated over a global network 200. FIG. 22A illustrates one such exemplary embodiment. The method begins in block 1002.

In block 1002, a NEEDS BRIEF or a TECHNICAL TARGET, from the CORPORATE MEMBER, can be harvested or otherwise created for at least one of the CORPORATE MEMBER. In this regard, NEEDS can be submitted, collected, or otherwise harvested from a CORPORATE MEMBER 102 and TECHNICAL TARGET created which clearly articulates a NEED so that a TECHNICAL COMMUNITY can understand the challenge and respond with PROPOSED SOLUTIONS. The method moves to block 1004.

In block 1004, the NEEDS BRIEF or the TECHNICAL TARGET can be shared with the TECHNICAL COMMUNITY. In an exemplary embodiment, it is preferable to share the TECHNICAL TARGET with a broad audience and to share the NEEDS BRIEF in more intimate settings, such as in a lecture, or meeting with a smaller group of researchers or technologists. Reason for this is that NEEDS BRIEFS are often brief and don't contain all the well articulate facts that a TECHNICAL TARGET typically does. As such, in more intimate settings the NEEDS BRIEFS can be discussed to ferret out a clear understand, whereas when TECHNICAL TARGETS are broadcast or otherwise shared widely no such mechanism to conveniently sharing additional insights easily exists.

In a plurality of exemplary embodiments, sharing the NEEDS BRIEF or TECHNICAL TARGET can include distributing the NEEDS BRIEF or TECHNICAL TARGET on data processing resource 202 associated with the COMMUNITY LED OPEN INNOVATION 100 systems and methods; within the online community 100. Sharing the NEEDS BRIEF or TECHNICAL TARGET can include distributing the NEEDS BRIEF and TECHNICAL TARGET on social media, such as LINKEDIN, FACEBOOK, and other social media networks. Sharing the NEEDS BRIEF or TECHNICAL TARGET can include distributing the NEEDS BRIEF or the TECHNICAL TARGET by way of email, mailing lists, SMS text messaging, MMS text messaging, or other similar types and/or kinds digitally transmitting the NEEDS BRIEF or TECHNICAL TARGET to other digital devices and servers. Sharing the NEEDS BRIEF or TECHNICAL TARGET can include distributing the NEEDS BRIEF or TECHNICAL TARGET in other ways, as may be required and/or desired in a particular embodiment. The method moves to block 1006.

In block 1006, received proposals, also referred to as PROPOSED SOLUTIONS, that are responsive to the NEEDS BRIEF or the TECHNICAL TARGET from the TECHNICAL COMMUNITY are delivered to the CORPORATE MEMBER for assessment. Such delivery can be data records on a data process resource associated with the COMMUNITY LED OPEN INNOVATION 100 system and method or can be emailed, posted, or otherwise digitally sent to other digital devices or servers. The method moves to block 1008.

In block 1008, the received PROPOSED SOLUTIONS are assessed by the CORPORATE MEMBER. Such assessment can be by a SUBJECT MATTER EXPERT 108 and such assessment can include assessing the proposal on technical merits of feasibility, likelihood of success, fit for use, and other merits. In addition, the SME 108 can work with Legal, Regulatory, and other functions to insure the PROPOSED SOLUTION is patent protectable or has freedom to operate, or meets other Legal or Regulatory requirements. The method then moves to block 1010.

In block 1010, the TECHNICAL COMMUNITY can then be engaged to effectuate a STATEMENT OF WORK. In this regard, after successful assessment of the PROPOSED SOLUTION and a desire to start work with the TECHNICAL COMMUNITY MEMBER who submitted the PROPOSED SOLUTION, a STATEMENT OF WORK for an EXPLORATION PROJECT, PILOT PROJECT, or COMMERCIALIZATION PROJECT can be initiated. The method is then exited.

Referring to FIG. 22B there is illustrated one example of COMMUNITY LED OPEN INNOVATION 100 system and method operated over a global network 200. The method begins in block 1012.

In block 1012, a TECHNICAL TARGET based on a NEED from a CORPORATE MEMBER can be created. In this regard, NEEDS can be submitted, collected, or otherwise harvested from the CORPORATE MEMBER 102 and TECHNICAL TARGETS created which clearly articulates a NEED so that a TECHNICAL COMMUNITY can understand the challenge and respond with PROPOSED SOLUTIONS. The method moves to block 1014.

In block 1014, the TECHNICAL TARGET can be shared with the TECHNICAL COMMUNITY. In a plurality of exemplary embodiments, sharing the TECHNICAL TARGET can include distributing the TECHNICAL TARGET on data processing resource 202 associated with the COMMUNITY LED OPEN INNOVATION 100 system and method; within the online community 100. Sharing the TECHNICAL TARGET can include distributing the TECHNICAL TARGET on social media, such as LINKEDIN, FACEBOOK, and other social media networks. Sharing the TECHNICAL TARGET can include distributing the TECHNICAL TARGET by way of email, mailing lists, SMS text messaging, MMS text messaging, or other similar types and/or kinds digitally transmitting the NEEDS BRIEF or TECHNICAL TARGET to other digital devices and servers. Sharing the TECHNICAL TARGET can include distributing the TECHNICAL TARGET in other ways, as may be required and/or desired in a particular embodiment. The method moves to block 1016.

In block 1016, the PROPOSED SOLUTION to a TECHNICAL TARGET can be initiated by a TECHNICAL COMMUNITY MEMBER or other person and routed to the CORPORATE MEMBER. In this regard, when the TECHNICAL COMMUNITY MEMBER sees the TECHNICAL TARGET and feels he or she has a solution, the TECHNICAL COMMUNITY MEMBER can propose a solution. This is accomplished on a data processing resource 202 associated with the COMMUNITY LED OPEN INNOVATION 100 system and method; in the online community. Replying to a TECHNICAL TARGET can include an initial step of redirecting the respondent to the online community where they can join or login and then propose their solution. The method moves to block 1018.

In block 1018, an introduction by way of a transitory anonymous communication between the CORPORATE MEMBER and the TECHNICAL COMMUNITY MEMBER can be facilitated within the online community 100. The anonymous nature of the communication protects the company name seeking solutions as well as the submitter until both sides are comfortable.

In this regard, in an exemplary, not only do the CORPORATE MEMBER and the TECHNICAL COMMUNITY MEMBER remain anonymous but the communication between them stays data storage 208 in the online community, that is, on a data processing resource 202 associated with the COMMUNITY LED OPEN INNOVATION 100 system and method. This allows the CORPORATE MEMBER and the TECHNICAL COMMUNITY MEMBER to have typically anonymous, non-confidential, introductory type, transitory communications, while protecting the CORPORATE MEMBER and the TECHNICAL COMMUNITY MEMBER identity as well as protect each from receiving into their respective organizations any unsolicited emails or other digital communications that may contain confidential information.

Most organizations have policies on when and what kind of information can be received and typically receiving unsolicited confidential information is not permitted. The transitory communication approach, in the present invention, prevents this scenario from occurring.

In this transitory communication approach, communications reside only on a data processing resource 202 associated with the COMMUNITY LED OPEN INNOVATION 100 system and method; in the online community. As such, a feature in the community is that such transitory communications can be purged or otherwise erased by the CORPORATE MEMBER or the COMMUNITY FACILITATOR.

An advantage, in the present invention, is that once a CORPORATE MEMBER makes a connection with a TECHNICAL COMMUNITY MEMBER and they take their business relationship outside the community, the CORPORATE MEMBER can elect to erase any communications between them so that nothing inadvertently becomes public information. In this regard, intellectual property, confidentiality, and trade secrets rely on carefully controlling public disclosure. The transitory communication approach, in the present invention, keeps all communication in a single location on server 202, storage 208 other than a CORPORATE MEMBER or TECHNICAL COMMUNITY MEMBER data processing resource. The arrangement engenders the ability for the CORPORATE MEMBER to erase the transitory communication in its entirety to help preserve confidentiality. Often this can be desirable when the CORPORATE MEMBER and the TECHNICAL COMMUNITY MEMBER take their newly formed partnering relationship offline and enter into traditional business discussion; outside the community. The method is then exited.

Referring to FIG. 22C there is illustrated one example of COMMUNITY LED OPEN INNOVATION 100 system and method operated over a global network 200. The method begins in block 1020.

In block 1020, a TECHNICAL TARGET based on a NEED from a CORPORATE MEMBER can be created. In this regard, NEEDS can be submitted, collected, or otherwise harvested from the CORPORATE MEMBER 102 and TECHNICAL TARGETS created which clearly articulates a NEED so that a TECHNICAL COMMUNITY can understand the challenge and respond with PROPOSED SOLUTIONS. The method moves to block 1022.

In block 1022, the TECHNICAL TARGET can be shared with the TECHNICAL COMMUNITY. In a plurality of exemplary embodiments, sharing the TECHNICAL TARGET can include distributing the TECHNICAL TARGET on data processing resource 202 associated with the COMMUNITY LED OPEN INNOVATION 100 system and method; within the online community 100. Sharing the TECHNICAL TARGET can include distributing the TECHNICAL TARGET on social media, such as LINKEDIN, FACEBOOK, and other social media networks. Sharing the TECHNICAL TARGET can include distributing the TECHNICAL TARGET by way of email, mailing lists, SMS text messaging, MMS text messaging, or other similar types and/or kinds digitally transmitting the NEEDS BRIEF or TECHNICAL TARGET to other digital devices and servers. Sharing the TECHNICAL TARGET can include distributing the TECHNICAL TARGET in other ways, as may be required and/or desired in a particular embodiment. The method moves to block 1024.

In block 1024, the PROPOSED SOLUTION to a TECHNICAL TARGET can be initiated by a TECHNICAL COMMUNITY MEMBER or other person and routed to the COMMUNITY FACILITATOR. In this regard, when the TECHNICAL COMMUNITY MEMBER sees the TECHNICAL TARGET and feels he or she has a solution, the TECHNICAL COMMUNITY MEMBER can propose a solution. This is accomplished on a data processing resource 202 associated with the COMMUNITY LED OPEN INNOVATION 100 system and method; in the online community. Replying to a TECHNICAL TARGET can include an initial step of redirecting the respondent to the online community where they can join or login and then propose their solution. The COMMUNITY FACILITATOR can be an agent for a CORPORATE MEMBER, acting on the CORPORATE MEMBERS behalf as PROPOSED SOLUTIONS are submitted by TECHNICAL COMMUNITY MEMBERS. The method moves to block 1026.

In block 1026, an introduction by way of a transitory anonymous communication between the COMMUNITY FACILITATOR and the TECHNICAL COMMUNITY MEMBER can be facilitated within the online community 100. The anonymous nature of the communication protects the company name seeking solutions as well as the submitter until both sides are comfortable.

In this regard, in an exemplary, not only do the COMMUNITY FACILITATOR, CORPORATE MEMBER, and the TECHNICAL COMMUNITY MEMBER remain anonymous but the communication between them stays on data storage 208 in the online community, that is, on a data processing resource 202 associated with the COMMUNITY LED OPEN INNOVATION 100 system and method. This allows the COMMUNITY FACILITATOR and the TECHNICAL COMMUNITY MEMBER to have typically anonymous, non-confidential, introductory type, transitory communications, while protecting the CORPORATE MEMBER and the TECHNICAL COMMUNITY MEMBER identity as well as protecting each from receiving into their respective organizations any unsolicited emails or other digital communications that may contain confidential information.

Most organizations have policies on when and what kind of information can be received and typically receiving unsolicited confidential information is not permitted. The transitory communication approach, in the present invention, prevents this scenario from occurring.

In this transitory communication approach, communications reside only on a data processing resource 202 associated with the COMMUNITY LED OPEN INNOVATION 100 system and method; in the online community. As such, a feature in the community is that such transitory communications can be purged or otherwise erased by the COMMUNITY FACILITATOR or the CORPORATE MEMBER.

An advantage, in the present invention, is that once a CORPORATE MEMBER makes a connection with a TECHNICAL COMMUNITY MEMBER and they take their business relationship outside the community, the CORPORATE MEMBER of COMMUNITY FACILITATOR can elect to erase any communications between them so that nothing inadvertently becomes public information. In this regard, intellectual property, confidentiality, and trade secrets rely on carefully controlling public disclosure. The transitory communication approach, in the present invention, keeps all communication in a single location on server 202, storage 208 other than a CORPORATE MEMBER or TECHNICAL COMMUNITY MEMBER data processing resource. The arrangement engenders the ability for the CORPORATE MEMBER to erase the transitory communication in its entirety to help preserve confidentiality. Often this can be desirable when the CORPORATE MEMBER and the TECHNICAL COMMUNITY MEMBER take their newly formed partnering relationship offline and enter into traditional business discussion; outside the community. The method is then exited.

Referring to FIG. 22D there is illustrated one example of COMMUNITY LED OPEN INNOVATION 100 system and method operated over a global network 200. The method begins in block 1028.

In block 1028, a TECHNICAL TARGET based on a NEED from a CORPORATE MEMBER can be created. In this regard, NEEDS can be submitted, collected, or otherwise harvested from the CORPORATE MEMBER 102 and TECHNICAL TARGETS created which clearly articulates a NEED so that a TECHNICAL COMMUNITY can understand the challenge and respond with PROPOSED SOLUTIONS. The method moves to block 1030.

In block 1030, the TECHNICAL TARGET can be shared with the TECHNICAL COMMUNITY. In a plurality of exemplary embodiments, sharing the TECHNICAL TARGET can include distributing the TECHNICAL TARGET on data processing resource 202 associated with the COMMUNITY LED OPEN INNOVATION 100 system and method; within the online community 100. Sharing the TECHNICAL TARGET can include distributing the TECHNICAL TARGET on social media, such as LINKEDIN, FACEBOOK, and other social media networks. Sharing the TECHNICAL TARGET can include distributing the TECHNICAL TARGET by way of email, mailing lists, SMS text messaging, MMS text messaging, or other similar types and/or kinds digitally transmitting the NEEDS BRIEF or TECHNICAL TARGET to other digital devices and servers. Sharing the TECHNICAL TARGET can include distributing the TECHNICAL TARGET in other ways, as may be required and/or desired in a particular embodiment. The method moves to block 1032.

In block 1032, the PROPOSED SOLUTION to a TECHNICAL TARGET can be initiated by a TECHNICAL COMMUNITY MEMBER or other person and routed to the CORPORATE MEMBER. In this regard, when the TECHNICAL COMMUNITY MEMBER sees the TECHNICAL TARGET and feels he or she has a solution, the TECHNICAL COMMUNITY MEMBER can propose a solution. This is accomplished on a data processing resource 202 associated with the COMMUNITY LED OPEN INNOVATION 100 system and method; in the online community. Replying to a TECHNICAL TARGET can include an initial step of redirecting the respondent to the online community 100 where they can join or login and then propose their solution. The method moves to block 1034.

In block 1034, the CORPORATE MEMBER is allowed to and can indicate, by checking or selecting in a data record or other way that a PROPOSED SOLUTION will be progressed to an ENGAGEMENT with a STATEMENT OF WORK. In this regard, the PROPOSED SOLUTION, now an ENGAGEMENT with a STATEMENT OF WORK can be tracked and reported on in PORTFOLIO VISUALIZATIONS. Absent the CORPORATE MEMBER making such indication it would be hard to know the status or progress of an OPPORTUNITY once it reached the ENGAGEMENT stage in the process. The method then moves to block 1036.

In block 1036, a PORTFOLIO VISUALIZATION can be presented to the CORPORATE MEMBER. In this regard, a representation of PIPELINE ACTIVITY, including the PROPOSED SOLUTION, now an ENGAGEMENT with a STATEMENT OF WORK can be presented or otherwise illustrated so that the CORPORATE MEMBER can see, print, send, or otherwise use such information to manage an innovation portfolio. The method is then exited.

Referring to FIG. 22E there is illustrated one example of COMMUNITY LED OPEN INNOVATION 100 system and method operated over a global network 200. The method begins in block 1038.

In block 1038, a TECHNICAL TARGET based on a NEED from a CORPORATE MEMBER can be created. In this regard, NEEDS can be submitted, collected, or otherwise harvested from the CORPORATE MEMBER 102 and TECHNICAL TARGETS created which clearly articulates a NEED so that a TECHNICAL COMMUNITY can understand the challenge and respond with PROPOSED SOLUTIONS. The method moves to block 1040.

In block 1040, the TECHNICAL TARGET can be shared with the TECHNICAL COMMUNITY. In a plurality of exemplary embodiments, sharing the TECHNICAL TARGET can include distributing the TECHNICAL TARGET on data processing resource 202 associated with the COMMUNITY LED OPEN INNOVATION 100 system and method; within the online community 100. Sharing the TECHNICAL TARGET can include distributing the TECHNICAL TARGET on social media, such as LINKEDIN, FACEBOOK, and other social media networks. Sharing the TECHNICAL TARGET can include distributing the TECHNICAL TARGET by way of email, mailing lists, SMS text messaging, MMS text messaging, or other similar types and/or kinds digitally transmitting the NEEDS BRIEF or TECHNICAL TARGET to other digital devices and servers. Sharing the TECHNICAL TARGET can include distributing the TECHNICAL TARGET in other ways, as may be required and/or desired in a particular embodiment. The method moves to block 1042.

In block 1042, the PROPOSED SOLUTION to a TECHNICAL TARGET can be initiated by a TECHNICAL COMMUNITY MEMBER or other person and aggregated, for assessment by the CORPORATE MEMBER. In this regard, when the TECHNICAL COMMUNITY MEMBER sees the TECHNICAL TARGET and feels he or she has a solution, the TECHNICAL COMMUNITY MEMBER can propose a solution. This is accomplished on a data processing resource 202 associated with the COMMUNITY LED OPEN INNOVATION 100 system and method; in the online community 100. Replying to a TECHNICAL TARGET can include an initial step of redirecting the respondent to the online community where they can join or login and then propose their solution. Once the PROPOSED SOLUTION submission is made it can be aggregated and held in a batch of PROPOSED SOLUTIONS so that at a later time the CORPORATE MEMBER can assess each of the PROPOSED SOLUTIONS. The method moves to block 1044.

In block 1044, a PORTFOLIO VISUALIZATION can be presented to the CORPORATE MEMBER. In this regard, a representation of PIPELINE ACTIVITY, including the aggregated PROPOSED SOLUTIONS can be presented or otherwise illustrated so that the CORPORATE MEMBER can see, print, send, assess, or otherwise use such information to manage an innovation portfolio. The method is then exited.

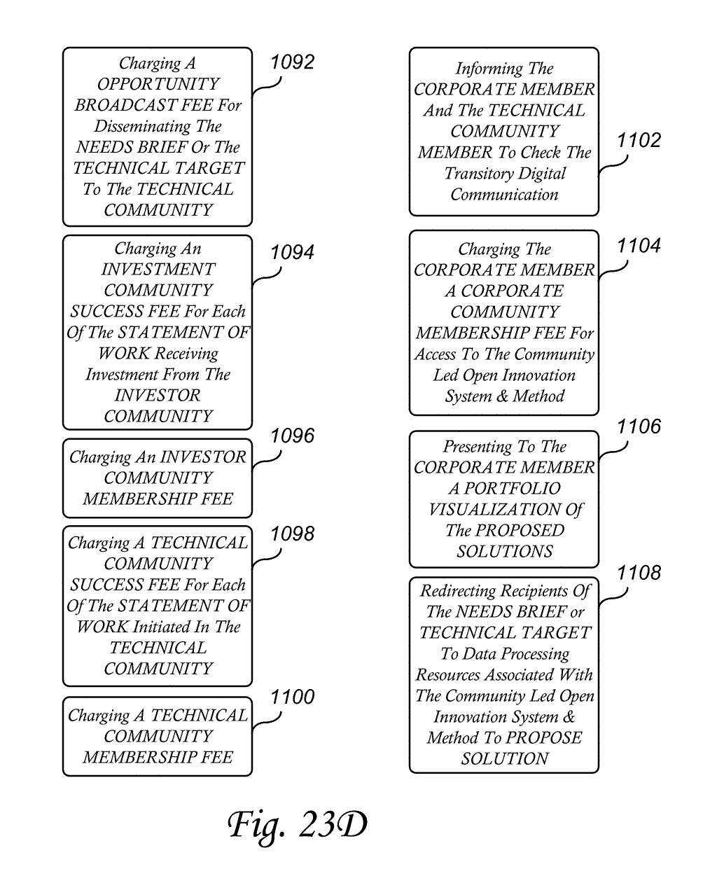

Referring to FIGS. 23A, 23B, 23C, 23D, and 23E there is illustrated exemplary embodiments of a COMMUNITY LED OPEN INNOVATION 100 system and method operated over a global network 200. Such exemplary embodiments can be selectively utilized with the methods of the present invention.

With reference to FIG. 23A, in block 1046, intellectual property rights associated with the PROPOSED SOLUTION can be secured prior to the step of engaging. In this regard, identifying and protecting intellectual property right prior to engaging a TECHNICAL COMMUNITY MEMBER or further progressing in the TECHNICAL COMMUNITY can be effectuated.

In block 1048, prior to sharing the NEEDS BRIEF of the TECHNICAL TARGET with the TECHNICAL COMMUNITY approval from the ACCOUNTABILITY BOARD is obtained.

In block 1050, approvals can be obtained from the SUBJECT MATTER EXPERT and the ACCOUNTABILITY BOARD. In this regard, at predetermined steps in the COMMUNITY LED OPEN INNOVATION 100 system and method approvals to advance OPPORTUNITIES, sharing with external communities or recommending the progressing of the OPPORTUNITY through the COMMUNITY LED OPEN INNOVATION 100 system and method can be obtained from the SUBJECT MATTER EXPERT and the ACCOUNTABILITY BOARD.

In block 1052, prior to the step of engaging, approval from the ACCOUNTABILITY BOARD is obtained.

In block 1054, A TECHNICAL READINESS rating is assigned to the OPPORTUNITY. Such OPPORTUNITY can be a NEEDS BRIEF, TECHNICAL TARGET, PROPOSED SOLUTION, or STATEMENT OF WORK. In an exemplary embodiment, the TECHNOLOGY READINESS rating can be assigned by way of a customizable lookup table as illustrated in at least FIG. 14 and corresponding disclosure.

Referring to FIG. 23B there is illustrated exemplary embodiments of a COMMUNITY LED OPEN INNOVATION 100 system and method operated over a global network 200. Such exemplary embodiments can be selectively utilized with the methods of the present invention.

In block 1056, an OPPORTUNITY VALUE rating is assigned to the OPPORTUNITY which comprises NEEDS BRIEF, TECHNICAL TARGET, PROPOSED SOLUTION, or STATEMENT OF WORK. In an exemplary embodiment, the OPPORTUNITY VALUE rating can be assigned by way of a customizable lookup table as illustrated in at least FIG. 15 and corresponding disclosure.

In block 1058, an OPPORTUNITY COMPLEXITY CONFIDENCE LEVEL rating is assigned to the OPPORTUNITY which comprises NEEDS BRIEF, TECHNICAL TARGET, PROPOSED SOLUTION, or STATEMENT OF WORK. In an exemplary embodiment, the OPPORTUNITY COMPLEXITY CONFIDENCE LEVEL rating can be assigned by way of a customizable lookup table as illustrated in at least FIG. 16 and corresponding disclosure.

In block 1060, a PROBABILITY OF SUCCESS rating is assigned to the OPPORTUNITY which comprises NEEDS BRIEF, TECHNICAL TARGET, PROPOSED SOLUTION, or STATEMENT OF WORK. In an exemplary embodiment, the PROBABILITY OF SUCCESS rating is determined by a set of MATHEMATICALLY WEIGHTED QUESTIONS as illustrated in at least FIG. 17 and corresponding disclosure.

In block 1062, a COMMERCIAL READINESS rating is assigned to the OPPORTUNITY which comprises NEEDS BRIEF, TECHNICAL TARGET, PROPOSED SOLUTION, or STATEMENT OF WORK. In an exemplary embodiment, the COMMERCIAL READINESS rating is determined by a set of MATHEMATICALLY WEIGHTED QUESTIONS as illustrated in at least FIG. 18 and corresponding disclosure.

In block 1064, the user is prompted for recordation of an OPPORTUNITY INFORMATION QUESTIONNAIRE. In an exemplary embodiment, an OPPORTUNITY INFORMATION QUESTIONNAIRE can be completed for each OPPORTUNITY. This information can then be used to refer to the OPPORTUNITY and such information can be utilized in online communications, in reporting, and PORTFOLIO VISUALIZATIONS.

Use of the term “OPPORTUNITY INFORMATION QUESTIONNAIRE”, in the present invention, is intended to mean information about an OPPORTUNITY collected by way of a online form to be part of an OPPORTUNITY record stored on or accessible by the COMMUNITY LED OPEN INNOVATION 100 system and method data processing resource 202 and/or data storage 208.

In an exemplary embodiment, and as better illustrated in at least FIG. 13, such an OPPORTUNITY INFORMATION QUESTIONNAIRE can include a CURRENT STATUS STATEMENT which is the current status of the OPPORTUNITY. In addition, such OPPORTUNITY INFORMATION QUESTIONNAIRE can also include a BUSINESS IMPACT STATEMENT which is the positive impact the OPPORTUNITY could have on the business if successful. Such BUSINESS IMPACT STATEMENT can be, for example and not a limitation, how much money the OPPORTUNITY might save the business, or how many additional products might be sold, or how it will meet other business goals or objectives, or other business impact as may be required and/or desired in a particular embodiment. The OPPORTUNITY INFORMATION QUESTIONNAIRE can also include information about the OPPORTUNITY OWNER, images of the opportunity, and/or other types and/or kinds of information as may be required and/or desired in a particular embodiment.

In block 1066, an OPPORTUNITY SUMMARY BRIEF is generated, in part, from the OPPORTUNITY INFORMATION QUESTIONNAIRE.

In block 1068, investment is induced from the INVESTOR COMMUNITY by providing a PORTFOLIO VISUALIZATION.

In block 1070, decision making, to progress at least some of the OPPORTUNITIES through the COMMUNITY LED OPEN INNOVATION 100 system and method is engendered by providing a PORTFOLIO VISUALIZATION of a CORPORATE MEMBER'S PIPELINE ACTIVITY.

In block 1072, a COLLABORATION TEAM which can comprise a combination of the ENTREPRENEUR COMMUNITY, the MENTOR COMMUNITY, and the SUPPLY CHAIN COMMUNITY is organized by way of a COMMUNITY FACILITATOR.

Referring to FIG. 23C there is illustrated exemplary embodiments of a COMMUNITY LED OPEN INNOVATION 100 system and method operated over a global network 200. Such exemplary embodiments can be selectively utilized with the methods of the present invention.

In block 1074, by way of the COMMUNITY FACILITATOR, the COLLABORATION TEAM and the SUBJECT MATTER EXPERT or other member of the CORPORATE MEMBER are partnered to increase the PROBABILITY OF SUCCESS of the STATEMENT OF WORK.

In block 1076, at least one of a PERFORMANCE METRIC is provided, with respect to at least at least one CORPORATE MEMBER of the CORPORATE COMMUNITY, at least one of the TECHNICAL COMMUNITY, or at least one of the INVESTMENT COMMUNITY.

In block 1078, at least one of a PERFORMANCE METRIC is provided, with respect to at least one of a CORPORATE MEMBER of the CORPORATE COMMUNITY ranking, at least one member of the TECHNICAL COMMUNITY ranking, or at least one member of an INVESTOR COMMUNITY ranking.

In block 1080, the TECHNICAL COMMUNITY is segmented into GROUPS. In an exemplary embodiment such GROUPS can include universities, institutes, startups, students, entrepreneurs, investors, technical communities, geographic regions, countries, government agencies, and other groups as may be required and/or desired in a particular embodiment.

In block 1082, dissemination of an OPPORTUNITY is restricted to certain GROUPS based on a DISTRIBUTION CRITERIA. In an exemplary embodiment, a DISTRIBUTION CRITERIA can be a defined sequence, priority, and/or order of TECHNICAL COMMUNITY GROUPS to distribute the NEEDS BRIEF or TECHNICAL TARGET to. In this regard, a CORPORATE MEMBER may want to search the NEEDS BRIEF or TECHNICAL TARGET in a first GROUP, at specific universities, institutes (i.e. organizations), or technical communities, geographic regions (i.e. city, state, or country). Then extend the search to a second GROUP, and then to a third GROUP. This is in lieu of just sending the NEEDS BRIEF or TECHNICAL TARGET to all or to too many destinations at one time. The search in preferred locations and over a desired time period for PROPOSED SOLUTIONS can be part of a DISTRIBUTION CRITERIA. As such, in an exemplary embodiment, the DISTRIBUTION CRITERIA can restrict distribution to a plurality of institutes, a plurality of university, a plurality of technical communities, a plurality of geographic regions, or to specific other GROUPS.

As example, the CORPORATE MEMBER may have an agreement with a particular university and as such would like to search a NEEDS BRIEF or TECHNICAL TARGET their first. If nothing is found then a wider circle of distribution can be initiated, perhaps to other sources of technology in the State or region they are locate in; looking for local PROPOSED SOLUTIONS. If nothing is still found then the distribution circle can be widen to the Country or searched internationally to other sources of technology. Each CORPORATE MEMBER for each NEEDS BRIEF or TECHNICAL TARGET can define a DISTRIBUTION CRITERIA, as may be required and/or desired in a particular embodiment.

In block 1084, a CORPORATE COMMUNITY SUCCESS FEE is charged for each of the STATEMENT OF WORK initiated within the TECHNICAL COMMUNITY. In an exemplary embodiment, a CORPORATE COMMUNITY SUCCESS FEE is a payment made when a successful event or transaction occurs, such as when a STATEMENT OF WORK is initiated, or other successful event or transaction. In this regard, the CORPORATE COMMUNITY SUCCESS FEE can be a fixed success or award payment, a percentage of the value of the STATEMENT OF WORK also referred to as a CORPORATE COMMUNITY SUCCESS FEE PERCENTAGE, or other remuneration, as may be required and/or desired in a particular embodiment.

In block 1086, a CORPORATE COMMUNITY MEMBERSHIP FEE is charged. In an exemplary embodiment, a CORPORATE COMMUNITY MEMBERSHIP FEE can be a periodic fee paid by a CORPORATE MEMBER to be a member of the CORPORATE COMMUNITY and/or access the COMMUNITY LED OPEN INNOVATION 100 system and method, or gain access to other resources as may be required and/or desired in a particular embodiment.

In block 1088, a PORTFOLIO VISUALIZATION can be presented as a business intelligence report or other type of informational report to the CORPORATE MEMBER. In this regard, a representation of PIPELINE ACTIVITY, including the PROPOSED SOLUTION, now an ENGAGEMENT with a STATEMENT OF WORK can be presented or otherwise illustrated so that the CORPORATE MEMBER can see, print, send, or otherwise use such information to manage an innovation portfolio.

In block 1090, the PROPOSED SOLUTION to a TECHNICAL TARGET can be initiated by a TECHNICAL COMMUNITY MEMBER or other person and aggregated, for assessment by the CORPORATE MEMBER. In this regard, when the TECHNICAL COMMUNITY MEMBER sees the TECHNICAL TARGET and feels he or she has a solution, the TECHNICAL COMMUNITY MEMBER can propose a solution. This is accomplished on a data processing resource 202 associated with the COMMUNITY LED OPEN INNOVATION 100 system and method; in the online community. Replying to a TECHNICAL TARGET can include an initial step of redirecting the respondent to the online community where they can join or login and then propose their solution. Once the PROPOSED SOLUTION submission is made it can be aggregated and held in a batch of PROPOSED SOLUTIONS so that at a later time the CORPORATE MEMBER can assess each of the PROPOSED SOLUTIONS.

Referring to FIG. 23D there is illustrated exemplary embodiment of a COMMUNITY LED OPEN INNOVATION 100 system and method operated over a global network 200. Such exemplary embodiments can be selectively utilized with the methods of the present invention.

In block 1092, an OPPORTUNITY BROADCAST FEE is charged for disseminating the NEEDS BRIEFS or the TECHNICAL TARGET to the TECHNICAL COMMUNITY. In an exemplary embodiment, the OPPORTUNITY BROADCAST FEE can be a fee charged to communicate the NEEDS BRIEF or TECHNICAL TARGET from a CORPORATE MEMBER of the CORPORATE COMMUNITY to the TECHNICAL COMMUNITY and/or INVESTOR COMMUNITY, or other fee for services can be charged, as may be required and/or desired in a particular embodiment.

In block 1094, an INVESTMENT COMMUNITY SUCCESS FEE is charged for each of the STATEMENT OF WORK receiving investment from the INVESTOR COMMUNITY. In an exemplary embodiment, an INVESTMENT COMMUNITY SUCCESS FEE is a payment made for a successful event or transaction occurs, such as when a STATEMENT OF WORK is initiated, or other successful event or transaction occurs. In this regard, the INVESTMENT COMMUNITY SUCCESS FEE can be a fixed success or award payment, a percentage of the value of the STATEMENT OF WORK also referred to as an INVESTMENT COMMUNITY SUCCESS FEE PERCENTAGE, or other remuneration, as may be required and/or desired in a particular embodiment.

In block 1096, an INVESTOR COMMUNITY MEMBERSHIP FEE is charged. In an exemplary embodiment, an INVESTOR COMMUNITY MEMBERSHIP FEE can be a periodic fee to be a member of the INVESTOR COMMUNITY and/or access the COMMUNITY LED OPEN INNOVATION 100 system and method, or other fee, as may be required and/or desired in a particular embodiment.

In block 1098, a TECHNICAL COMMUNITY SUCCESS FEE is charged for each STATEMENT OF WORK initiated in the TECHNICAL COMMUNITY. In an exemplary embodiment, a TECHNICAL COMMUNITY SUCCESS FEE is a payment made for a successful event or transaction occurs, such as when a STATEMENT OF WORK is initiated, or other successful event or transaction occurs. In this regard, the TECHNICAL COMMUNITY SUCCESS FEE can be a fixed success or award payment, a percentage of the value of the STATEMENT OF WORK also referred to as a TECHNICAL COMMUNITY SUCCESS FEE PERCENTAGE, or other remuneration, as may be required and/or desired in a particular embodiment.

In block 1100, a TECHNICAL COMMUNITY MEMBERSHIP FEE is charged. In an exemplary embodiment, a TECHNICAL COMMUNITY MEMBERSHIP FEE can be a periodic fee to be a member of the TECHNICAL COMMUNITY and/or access the COMMUNITY LED OPEN INNOVATION 100 system and method, or other fee, as may be required and/or desired in a particular embodiment.

In block 1102, the CORPORATE MEMBER and the TECHNICAL COMMUNITY MEMBER can be informed to check the transitory digital communication which resides in the online community. In this regard, since the communication between the CORPORATE MEMBER and the TECHNICAL COMMUNITY MEMBER is managed and stays on a data processing resource that is associated with the COMMUNITY LED OPEN INNOVATION 100 system and method, an informing email, text, or other communication is sent to the CORPORATE MEMBER and the TECHNICAL COMMUNITY MEMBER when new content has been added to the transitory digital communication. To clarify, the transitory digital communication content is not sent, only a message like, “A new conversation has been added, please visit the website and check it out”. This informs the CORPORATE MEMBER and THE TECHNICAL COMMUNITY MEMBER to log into the online community and check the transitory digital communication, as new content has recently been added.

In block 1104, a CORPORATE MEMBER is charged the CORPORATE COMMUNITY MEMBERSHIP FEE. In an exemplary embodiment, a CORPORATE COMMUNITY MEMBERSHIP FEE can be a periodic fee paid by a CORPORATE MEMBER to be a member of the CORPORATE COMMUNITY and/or access the COMMUNITY LED OPEN INNOVATION 100 system and method, or gain access to other resources as may be required and/or desired in a particular embodiment.

In block 1106, a PORTFOLIO VISUALIZATION can be presented to the CORPORATE MEMBER. In this regard, a representation of PROPOSED SOLUTIONS can be presented or otherwise illustrated so that the CORPORATE MEMBER can see, print, send, or otherwise use such information to manage an innovation portfolio and make informed decisions.

In block 1108, recipients of the NEEDS BRIEF or the TECHNICAL TARGET can be redirected to the data processing resource 202 associated with the COMMUNITY LED OPEN INNOVATION 100 system and method; the online community to submit their PROPOSED SOLUTION.

Referring to FIG. 23E there is illustrated exemplary embodiment of a COMMUNITY LED OPEN INNOVATION 100 system and method operated over a global network 200. Such exemplary embodiments can be selectively utilized with the methods of the present invention.

In block 1110, selectively the transitory digital communication can be purged from the data processing resource 202 associated with the COMMUNITY LED OPEN INNOVATION 100 system and method; the online community 100. In an exemplary embodiment, most organizations have policies on when and what kind of information can be received and typically receiving unsolicited confidential information is not permitted. The transitory communication approach, in the present invention, prevents this scenario from occurring.

In this transitory communication approach, communications reside only on a data processing resource 202 associated with the COMMUNITY LED OPEN INNOVATION 100 system and method; in the online community 100. As such, a feature in the community 100 is that such transitory communications can be purged or otherwise erased by the CORPORATE MEMBER or the COMMUNITY FACILITATOR.

An advantage, in the present invention, is that once a CORPORATE MEMBER makes a connection with a TECHNICAL COMMUNITY MEMBER and they take their business relationship outside the community, the CORPORATE MEMBER can elect to erase any communications between them so that nothing inadvertently becomes public information. In this regard, intellectual property, confidentiality, and trade secrets rely on carefully controlling public disclosure. The transitory communication approach, in the present invention, keeps all communication in a single location on server 202, storage 208 other than a CORPORATE MEMBER or TECHNICAL COMMUNITY MEMBER data processing resource. The arrangement engenders the ability for the CORPORATE MEMBER to erase the transitory communication in its entirety to help preserve confidentiality. Often this can be desirable when the CORPORATE MEMBER and the TECHNICAL COMMUNITY MEMBER take their newly formed partnering relationship offline and enter into traditional business discussion; outside the community.

In block 1112, the NEEDS BRIEF or TECHNICAL TARGET can be distributed or otherwise shared on data processing resource 202 associated with the COMMUNITY LED OPEN INNOVATION 100 system and method; within the online community 100.

In block 1114, the NEEDS BRIEF or TECHNICAL TARGET can be distributed or otherwise shared on social media networks, such as LINKEDIN, FACEBOOK, and other social media networks.

In block 1116, the NEEDS BRIEF or TECHNICAL TARGET can be distributed or otherwise shared by way of email, mailing lists, SMS text messaging, MIMS text messaging, or other similar types and/or kinds digitally transmitting the NEEDS BRIEF or TECHNICAL TARGET to other digital devices and servers.

In block 1118, an introduction by way of a transitory anonymous communication between the COMMUNITY FACILITATOR and the TECHNICAL COMMUNITY MEMBER can be facilitated within the online community 100. The anonymous nature of the communication protects the company name seeking solutions as well as the submitter until both sides are comfortable.

In this regard, in an exemplary, not only do the COMMUNITY FACILITATOR and the TECHNICAL COMMUNITY MEMBER remain anonymous but the communication between them stays in the online community 100, that is, on a data processing resource 202 associated with the COMMUNITY LED OPEN INNOVATION 100 system and method. This allows the COMMUNITY FACILITATOR, CORPORATE MEMBER, and the TECHNICAL COMMUNITY MEMBER to have typically anonymous, non-confidential, introductory type, transitory communications, while protecting the COMMUNITY FACILITATOR, CORPORATE MEMBER, and the TECHNICAL COMMUNITY MEMBER identity as well as protect each from receiving into their respective organizations any unsolicited emails or other digital communications that may contain confidential information.

In this transitory communication approach, communications reside only on a data processing resource 202 associated with the COMMUNITY LED OPEN INNOVATION 100 system and method; in the online community 100. As such, a feature in the community is that such transitory communications can be purged or otherwise erased by the CORPORATE MEMBER or the COMMUNITY FACILITATOR.

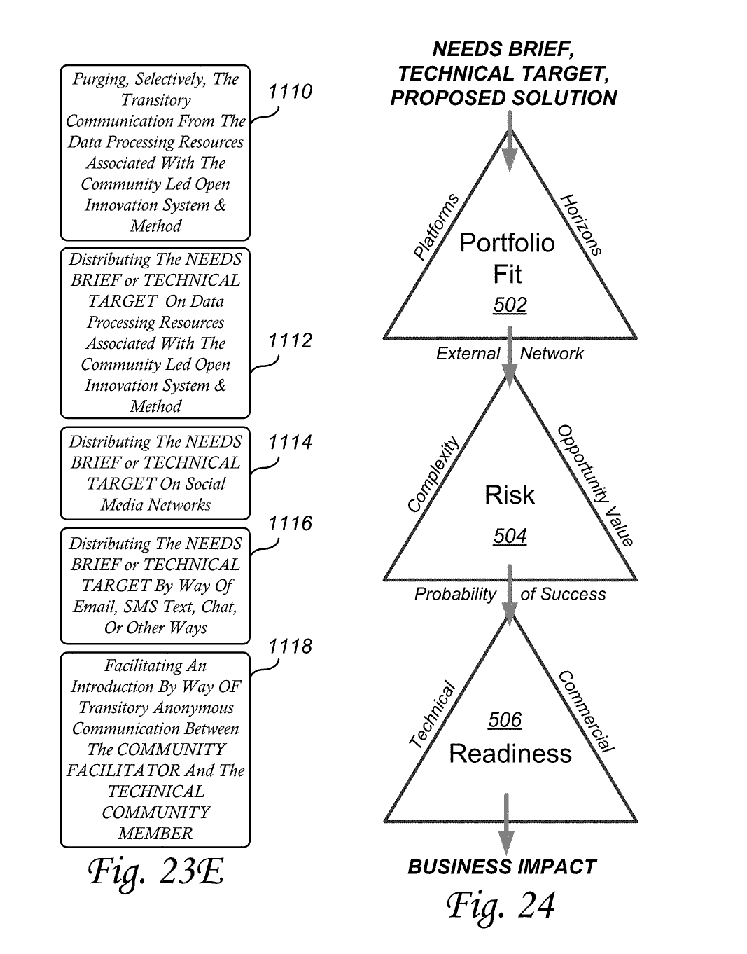

Referring to FIG. 24 there is illustrated one example of a COMMUNITY LED OPEN INNOVATION portfolio management framework. In an exemplary embodiment, a CORPORATE MEMBER can assess OPPORTUNITIES for OPPORTUNITY PORTFOLIO FIT 502, OPPORTUNITY RISK 504, and OPPORTUNITY READINESS 506. In this regard, the innovation management tools previously disclosed can be combined into a holistic innovation management framework approach. Such an approach can be leveraged to inform, track, provide success metrics, aid in decision making, generate PORTFOLIO VISUALIZATIONS, and provide other benefits.

OPPORTUNITY PORTFOLIO FIT 502 identifies the organizations strategic PLATFORMS, innovation HORIZONS and composition of external network partners. With respect to strategic PLATFORMS, PLATFORMS can be identified and goals can be set as to what percentage of the total innovation portfolio shall each PLATFORM be allocated. As an example, and not a limitation, strategic PLATFORM ‘Top line growth’ might be 40%, ‘Protecting core brands’ might be 30%, and ‘Sustainable and productivity savings’ might be 30% of the innovation portfolio. In a similar fashion HORIZONS can be set for HORIZONS 1, 2, and 3; core or incremental, breakthrough, and transformational. An external network of partners can also be identified and agreed with company leadership. In this regard, ‘where we look’, ‘who we work with’, and ‘how we will engage’ should be understood and agreed before PROPOSED SOLUTIONS start coming in. Examples and techniques for each of the PORTFOLIO FIT 602 elements have previously been disclosed.

OPPORTUNITY RISK 504 identifies the OPPORTUNITY VALUE, OPPORTUNITY COMPLEXITY CONFIDENCE LEVEL, and OPPORTUNITY PROBABILITY OF SUCCESS. Examples and techniques for each of the RISK 604 elements have previously been disclosed.

OPPORTUNITY READINESS 506 identifies OPPORTUNITY TECHNICAL READINESS, OPPORTUNITY COMMERCIAL READINESS, and BUSINESS IMPACT. Examples and techniques for each of the READINESS 606 elements have previously been disclosed.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A community led open innovation method, operated over a global network, in an online community format that engenders increase in the technology transfer rate of technologies, technical resources, and technical capabilities to a CORPORATE COMMUNITY from a TECHNICAL COMMUNITY, the community led open innovation method comprising the steps of:
creating a TECHNICAL TARGET based on a NEED from a CORPORATE MEMBER, the CORPORATE COMMUNITY further comprising the CORPORATE MEMBER;
sharing the TECHNICAL TARGET with the TECHNICAL COMMUNITY, the TECHNICAL COMMUNITY further comprising at least one of a TECHNICAL COMMUNITY MEMBER;
routing to the CORPORATE MEMBER a PROPOSED SOLUTION to the TECHNICAL TARGET, the PROPOSED SOLUTION being initiated by the TECHNICAL COMMUNITY MEMBER; and
facilitating an introduction, related to the PROPOSED SOLUTION, by way of a transitory digital communication between the CORPORATE MEMBER and the TECHNICAL COMMUNITY MEMBER.

2. The community led open innovation method in accordance with claim 1, wherein the identity of each of the CORPORATE MEMBER and the TECHNICAL COMMUNITY MEMBER remain anonymous and the transitory digital communication is effectuated and stored on a data processing resource associated with the community led open innovation method.

3. The community led open innovation method in accordance with claim 2, further comprising the step of:
purging, selectively, the transitory digital communication from the data processing resource associated with the community led open innovation method, wherein the CORPORATE MEMBER can purge the transitory digital communication when interaction with the TECHNICAL COMMUNITY MEMBER is concluded, leaving no-trace the transitory digital communication occurred.

4. The community led open innovation method in accordance with claim 1, further comprising the step of:
informing the CORPORATE MEMBER and the TECHNICAL COMMUNITY MEMBER to check the transitory digital communication when either the CORPORATE MEMBER or the TECHNICAL COMMUNITY MEMBER adds digital content to the transitory digital communication.

5. The community led open innovation method in accordance with claim 1, further comprising the step of:
charging the CORPORATE MEMBER a CORPORATE COMMUNITY MEMBERSHIP FEE for access to the community led open innovation method.

6. The community led open innovation method in accordance with claim 1, further comprising the step of:
assigning a TECHNOLOGY READINESS rating to the PROPOSED SOLUTION, the TECHNOLOGY READINESS rating being assigned by way of a first customizable lookup table.

7. The community led open innovation method in accordance with claim 6, further comprising the step of:
assigning an OPPORTUNITY VALUE rating to the PROPOSED SOLUTION, the OPPORTUNITY VALUE rating being assigned by way of a second customizable lookup table.

8. The community led open innovation method in accordance with claim 7, further comprising the step of:
assigning a PROBABILITY OF SUCCESS rating to the PROPOSED SOLUTION, the PROBABILITY OF SUCCESS rating is determined by a first set of MATHEMATICALLY WEIGHTED QUESTIONS.

9. The community led open innovation method in accordance with claim 8, further comprising the step of:
assigning an OPPORTUNITY COMPLEXITY CONFIDENCE LEVEL rating to the PROPOSED SOLUTION, the OPPORTUNITY COMPLEXITY CONFIDENCE LEVEL rating being assigned by way of a third customizable lookup table.

10. The community led open innovation method in accordance with claim 9, further comprising the step of:
assigning a COMMERCIAL READINESS rating to the PROPOSED SOLUTION, the COMMERCIAL READINESS rating is determined by a second set of MATHEMATICALLY WEIGHTED QUESTIONS.

11. The community led open innovation method in accordance with claim 1, wherein the step of sharing, further comprising the steps of:
segmenting the TECHNICAL COMMUNITY into a plurality of GROUPS; and
restricting sharing of the TECHNICAL TARGET to certain of the plurality of GROUPS based on a DISTRIBUTION CRITERIA, the DISTRIBUTION CRITERIA selecting which of the plurality of GROUPS receive the TECHNICAL TARGET.

12. A community led open innovation method, operated over a global network, in an online community format that engenders increase in the technology transfer rate of technologies, technical resources, and technical capabilities to a CORPORATE COMMUNITY from a TECHNICAL COMMUNITY, the community led open innovation method comprising the steps of:
creating a TECHNICAL TARGET based on a NEED from a CORPORATE MEMBER, the CORPORATE COMMUNITY further comprising the CORPORATE MEMBER;
segmenting the TECHNICAL COMMUNITY into a plurality of GROUPS;
restricting sharing of the TECHNICAL TARGET to certain of the plurality of GROUPS based on a DISTRIBUTION CRITERIA, the DISTRIBUTION CRITERIA selecting which of the plurality of GROUPS receive the TECHNICAL TARGET;
sharing the TECHNICAL TARGET with a subset of the TECHNICAL COMMUNITY based on the DISTRIBUTION CRITERIA, the TECHNICAL COMMUNITY further comprising at least one of a TECHNICAL COMMUNITY MEMBER;
routing to a CORPORATE MEMBER a PROPOSED SOLUTION to the TECHNICAL TARGET, the PROPOSED SOLUTION being initiated by the TECHNICAL COMMUNITY MEMBER; and
facilitating an introduction, related to the PROPOSED SOLUTION, by way of a transitory digital communication between the CORPORATE MEMBER and the TECHNICAL COMMUNITY MEMBER.

13. The community led open innovation method in accordance with claim 12, wherein the step of routing further comprising:
informing the CORPORATE MEMBER and the TECHNICAL COMMUNITY MEMBER to check the transitory digital communication when either the CORPORATE MEMBER or the TECHNICAL COMMUNITY MEMBER adds digital content to the transitory digital communication, the identity of each of the CORPORATE MEMBER, and the TECHNICAL COMMUNITY MEMBER remain anonymous.

14. The community led open innovation method in accordance with claim 12, further comprising the step of:
charging the CORPORATE MEMBER a CORPORATE COMMUNITY MEMBERSHIP FEE for access to the community led open innovation method.

15. The community led open innovation method in accordance with claim 12, further comprising the step of:
presenting to the CORPORATE MEMBER a PORTFOLIO VISUALIZATION of the PROPOSED SOLUTION.

16. The community led open innovation method in accordance with claim 12, further comprising the steps of:
assigning a TECHNOLOGY READINESS rating to at least one of the plurality of PROPOSED SOLUTIONS, the TECHNOLOGY READINESS rating being assigned by way of a first customizable lookup table;
assigning an OPPORTUNITY VALUE rating to at least one of the plurality of PROPOSED SOLUTIONS, the OPPORTUNITY VALUE rating being assigned by way of a second customizable lookup table; and
assigning a PROBABILITY OF SUCCESS rating to at least one of the plurality of PROPOSED SOLUTIONS, the PROBABILITY OF SUCCESS rating is determined by user answers to a first set of MATHEMATICALLY WEIGHTED QUESTIONS.

17. A community led open innovation method, operated over a global network, in an online community format that engenders increase in the technology transfer rate of technologies, technical resources, and technical capabilities to a CORPORATE COMMUNITY from a TECHNICAL COMMUNITY, the community led open innovation method comprising the steps of:
creating a TECHNICAL TARGET based on a NEED from a CORPORATE MEMBER, the CORPORATE COMMUNITY further comprising the CORPORATE MEMBER;
sharing the TECHNICAL TARGET with the TECHNICAL COMMUNITY, the TECHNICAL COMMUNITY further comprising at least one of a TECHNICAL COMMUNITY MEMBER;
routing to the CORPORATE MEMBER a PROPOSED SOLUTION to the TECHNICAL TARGET, the PROPOSED SOLUTION being initiated by the TECHNICAL COMMUNITY MEMBER;
facilitating an introduction, related to the PROPOSED SOLUTION, by way of a transitory digital communication between the CORPORATE MEMBER and the TECHNICAL COMMUNITY MEMBER, the identity of each of the CORPORATE MEMBER and the TECHNICAL COMMUNITY MEMBER remain anonymous and the transitory digital communication is effectuated and stored on a data processing resource associated with the community led open innovation method; and
informing the CORPORATE MEMBER and the TECHNICAL COMMUNITY MEMBER to check the transitory digital communication when either the CORPORATE MEMBER or the TECHNICAL COMMUNITY MEMBER adds digital content to the transitory digital communication.

18. The community led open innovation method in accordance with claim 17, the step of sharing further comprising the step of:
distributing the TECHNICAL TARGET on at least one of a social media network.

19. The community led open innovation method in accordance with claim 17, further comprising the steps of:
segmenting the TECHNICAL COMMUNITY into a plurality of GROUPS; and
restricting sharing of the TECHNICAL TARGET to certain of the plurality of GROUPS based on a DISTRIBUTION CRITERIA, the DISTRIBUTION CRITERIA selecting which of the plurality of GROUPS receive the TECHNICAL TARGET.

20. The community led open innovation method in accordance with claim 19, further the steps of:
assigning a TECHNOLOGY READINESS rating to the PROPOSED SOLUTION, the TECHNOLOGY READINESS rating being assigned by way of a first customizable lookup table;
assigning an OPPORTUNITY VALUE rating to the PROPOSED SOLUTION, the OPPORTUNITY VALUE rating being assigned by way of a second customizable lookup table;
assigning a PROBABILITY OF SUCCESS rating to the PROPOSED SOLUTION, the PROBABILITY OF SUCCESS rating is determined by a first set of MATHEMATICALLY WEIGHTED QUESTIONS;
assigning an OPPORTUNITY COMPLEXITY CONFIDENCE LEVEL rating to the PROPOSED SOLUTION, the OPPORTUNITY COMPLEXITY CONFIDENCE LEVEL rating being assigned by way of a third customizable lookup table; and
assigning a COMMERCIAL READINESS rating to the PROPOSED SOLUTION, the COMMERCIAL READINESS rating is determined by a second set of MATHEMATICALLY WEIGHTED QUESTIONS.
